(19) United States
(12) Patent Application Publication
(10) Pub. No.: US 2023/0196479 A1
(43) Pub. Date: Jun. 22, 2023

(54) COLLABORATIVE STORIES

(71) Applicant: Meta Platforms, Inc., Menlo Park, CA (US)

(72) Inventors: Sonja Okano Khan, Brooklyn, NY (US); Mari Sheibley, San Francisco, CA (US); Rennie Hsie Song, Stanford, CA (US); Kevin Joseph Hiscott, San Francisco, CA (US)

(21) Appl. No.: 17/557,935

(22) Filed: Dec. 21, 2021

(51) Int. Cl. G06Q 50/00

(52) U.S. Cl. CPC G06Q 50/01

(57) ABSTRACT

Techniques for generating ephemeral collections of content items are described herein. For example, a social networking system may receive, from a first account, a request to generate a collection of content items, or a “collaborative story.” The request may include an identifier associated with a second account that is to be associated with the collaborative story. Based on the request, the social networking system may generate the collaborative story and associate the second account therewith, designating the first account and the second account are as collaborators. In some examples, the social networking system may receive content from the first account and/or the second account and may publish the content in association with the collaborative story via the social networking system.

### BACKGROUND

Social networking systems by which users can share content provides users with numerous benefits and opportunities. For example, users may share information, media, and other types of content with family, friends, colleagues, and even strangers. However, the ability to share content on social networking systems is not without limitations. Most conventional social networking systems provide sharing in a one-to-many relationship via the user's account or page. In some examples, users may wish to share content, but may be hesitant to share content by themselves, in some examples discouraging users from creating and sharing content at all.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a schematic view of an example system usable to implement example techniques described herein.

FIGS. 2A-2F illustrate example interfaces useable to create a collaborative story.

FIGS. 3A-3D illustrate example interfaces usable to provide a notification that an account has been associated with a collaborative story.

FIGS. 4A-4C illustrate example interfaces usable for an account to add content to a collaborative story.

FIGS. 5A-5C illustrate example interfaces usable to view a collaborative story.

FIG. 6 illustrates an example interface usable to view a collaborative story from a profile of an account.

FIG. 7 illustrates an example interface usable to view collaborative stories from a feed of an account.

FIGS. 8A and 8B illustrate example interfaces usable for accounts to comment on a collaborative story.

FIG. 9 illustrates an example process for creating collaborative stories.

FIG. 10 illustrates an example system and device which may be used to implement the techniques described herein.

### DETAILED DESCRIPTION

As discussed above, controlling how content is shared on digital platforms presents challenges. For example, digital platforms, such as social networking systems, are often used to share content associated with events, occasions, projects, and the like. The content is often attributable or related to multiple users associated with accounts of the social networking system. However, conventional systems often only allow a single account to post, upload, or otherwise share content to the social networking system. Due to this solitary nature of posting content, individual users may be fearful of judgment when sharing content. For example, a user of an account may wish to share content about a specific topic, but may be fearful of derision from others. Thus, users may limit content created and shared via a social media platform, thereby diminishing the value of the digital platform.

This application describes techniques for enabling users the ability to collaborate with other users regarding a specific topic, event, or the like. For example, a social networking platform can enable a user to create a collection of items of content, herein referred to as a “collaborative story,” in which multiple users may post content to a single collection, the content sharing a common theme or topic. The user can associate select other users with the collaborative story, enabling the selected other users to publish content in association with the collaborative story. Additionally, in some examples, still other users may request to access the content and/or become collaborators associated with the collaborative story, ensuring a dynamic experience which reaches accounts interested in the theme or topic. In this way, users may be encouraged to create and share content without the fear of judgment or unengaged audiences.

Additionally, the collaborative story may provide an efficient means by which users may share content associated with a collective event. That is, users who participate in a collective event may join together to share content associated with the collective event with a larger audience than any single user may reach. For example, a first user may vacation with a group of friends. The first user may establish a collaborative story between the friends vacationing together, enabling the friends to all contribute, or post content, to the collaborative story. The collaborative story may then be published to connections of the contributors (e.g., the friends vacationing together), enabling content to be shared to a wide variety of other users. This collaborative story telling provides a means for a more tailored and inclusive experience for both the accounts posting content and the accounts following the content (e.g., connections of the users associated with the collaborative story viewing the collaborative story). In this way, the techniques described herein may promote participation, improve relationships, encourage creativity, and so forth.

Various examples of the present disclosure include systems, methods, and non-transitory computer-readable media of a social networking system. In some examples, a social networking system may receive, from a first account of the social networking system, a request to generate an ephemeral collection of content items, or “collaborative story.” The collaborative story may be a collaboration between two or more accounts of the social networking system. In some examples, the request may include an identifier associated with a second account of the social networking system that is to be associated with the collaborative story. In response to receiving the request including the item identifier associated with the second account, the social networking system may associate the second account with the collaborative story. For example, the second account may be designated as a contributor of the collaborative story, allowing both the first account and the second account to post content to the collaborative story. In some examples, a story component of the social networking system may generate the collaborative story between the first account and the second account. In response to generating the collaborative story, the social networking system may further receive content from at least one of the first account or the second account. Content may take a variety of forms, such as text and/or media content items, such as images, video, and/or audio. In response to receiving the content, the social networking system may cause presentation, via a third account, of the content in association with the collaborative story. In some examples, the social networking system may cause presentation of an indication of at least one of the first account and/or the second account associated with a publisher of a particular content item associated with the collaborative story.

In some examples, the social networking system may further receive, from the second account, a request to dissociate from the collaborative story, thus no longer allowing the second account to share content to the collaborative story. In response to receiving the request to dissociate, the social networking system may remove the identifier associated with the second account from the collaborative story. In some examples, in response to dissociating the second account, the social networking system may permit the second account to access the collaborating, without enabling the publication of content to the collaborative story in association with the second account.

In some examples, the social networking system may receive, from the third account, a request to access the collaborative story, wherein causing presentation of collaborative story via display of the computing device associated with the third account may be based on the request to access the collaborative story. For example, the user associated with the third account may wish to follow the collaborative story, allowing the third account to view content and updates posted in associated with the collaborative story. Associating with the collaborative story may result in content from the collaborative story being presented to the third account in a variety of ways, such as in a feed of the third user or a profile associated with the first account and/or the second account, to name a few examples.

In some examples, the social networking system may receive, from the third account, a request to join the collaborative story as a contributor. In response to the request, the social networking system may cause presentation, to the first account and/or the second account, at least a portion of the request. In some examples, the social networking system may present options to accept or deny the request. In response to receiving an indication of acceptance of the request to join the collaborative story, the social networking system may associate the third account with the collaborative story, wherein the third account may be designated as a collaborator. Alternatively, in response to receiving an indication of denial of the request to join the collaborative story, the social networking system may send, to the third account, a notification that the third account has not been designated as a collaborator of the collaborative story.

In some examples, the content may be first content, and the indication may be a first indication. In response to associating the third account with the collaborative story, the social networking system may, in some examples, receive second content to share to the collaborative story. The social networking system may further cause presentation, via a display of another computing device associated with a fourth account, the second content and a second indication that the third account is associated with the second content. In some examples, the fourth account may be connected to at least one of the first account, the second account, or the third account via the social networking system.

In some examples, the social networking system may determine that the first account is a public account and that the second account is a private account. Additionally, the social networking system may determine that the third account is a follower of the public account. In some examples, the social networking system may further cause presentation, in association with the second account and based on determining that the first account is a public account, of a notification that sharing the content to the collaborative story includes sharing content publicly.

In some examples, the content may be an item of ephemeral content. For example, as described above with respect to the collaborative story, content shared to the collaborative story may be removed from view in association with the collaborative story after a threshold period of time (e.g., one hour, one day, one week, etc.).

In some examples, the social networking system may receive, from the third account, a comment in response to the content and associated with the collaborative story. The social networking system may further receive, from at least one of the first account or the second account, a response to the comment. In response to receiving the response to the comment, the social networking system may, in some examples, cause presentation of at least one of the comment or the response in a communication interface associated with the collaborative story. The communication interface may be accessible to the collaborators of the collaborative story, other users associated with or connected to the collaborative story, and/or viewers of the collaborative story.

In some examples, the social networking system may provide, to the second account and based on an association with the collaborative story, a selectable icon. For example, the selectable icon may be associated with a sticker or other interface elements that may enable the second account to incite other accounts to associate with the collaborative story. The social networking system may then receive, from the second account, a request to share the selectable icon to a story of the second account. In response to receiving the request, the social networking system may cause presentation of the selectable icon in association with the story of the second account, allowing the second account to invite other accounts to access the collaborative story.

In some examples, the social networking system may determine that the first account and the second account are private accounts. The social networking system may further determine that the third account is associated with the first account and the second account. Thus, causing presentation of the collaborative story may be based on determining that the third account is associated with the first account and the second account. For example, the social networking system may render available for view data associated with accounts to which the viewing user is connected.

These techniques allow multiple accounts to post content to a collaborative story accessible to an opted-in audience. By enabling users the freedom post content with other users, users sharing content are afforded the flexibility and encouragement to create and share content without pressure and fear of judgment.

Additionally, in conventional systems, in order for a user to share, via a user account, content created or captured by other users, the other users would be required to send the content to the user via a communication channel. That is, for a first user to share, via a feed associated with a first user account, content created or captured by a second user, the second user would have to send the content to the a computing device of the first user, via which the first user could upload the data to the feed. Unlike these conventional systems, the techniques described herein enable the first user and the second user to upload data directly to the feed, thereby reducing a number of times that the content is transmitted via a network. As such, the techniques described herein reduce an amount of network bandwidth required to publish content to a feed, thereby increase the amount of network bandwidth available for other resources. Further, the techniques described herein remove the requirement for the computing device of the first user to receive and store the content from the second user in association with publishing the content to the feed. As such, the techniques described herein improve the functioning of the computing device of the first user by increasing an amount of memory and processing power available thereto.

These and other aspects are described further below with reference to the accompanying drawings. The drawings are merely example implementations and should not be construed to limit the scope of the claims. For example, while examples are illustrated in the context of a user interface for a mobile device, the techniques may be implemented using any computing device and the user interface may be adapted to the size, shape, and configuration of the particular computing device.

### Example System Architecture

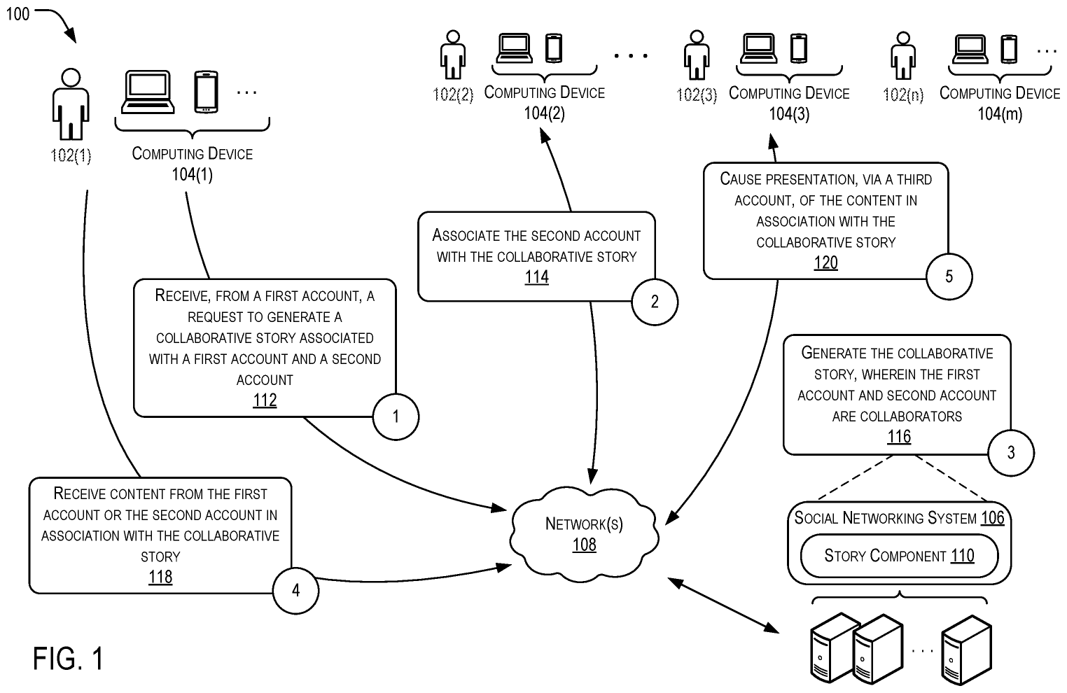

FIG. 1 is a schematic view of an example computing system 100 usable to implement example techniques described herein to create ephemeral collections of content items. In some examples, the computing system 100 may include accounts 102(1), 102(2), . . . 102(n) (collectively “accounts 102”) that are associated with users and interact using computing devices 104(1), 104(2), . . . 104(m) (collectively “computing devices 104”) with a social networking system 106 via a network 108. In this example, n and m are non-zero integers greater than 1.

Each of the computing devices 104 includes one or more processors and memory storing computer executable instructions to implement the functionality discussed herein attributable to the various computing devices. In some examples, the computing devices 104 may include desktop computers, laptop computers, tablet computers, mobile devices (e.g., smart phones or other cellular or mobile phones, mobile gaming devices, portable media devices, etc.), wearable devices (e.g., augmented reality or virtual reality devices, glasses, watches, etc.), or other suitable computing devices. The computing devices 104 may execute one or more client applications, such as a web browser (e.g., Microsoft Windows Internet Explorer, Mozilla Firefox, Apple Safari, Google Chrome, Opera, etc.) or a native or special-purpose client application (e.g., social media applications, messaging applications, email applications, games, etc.), to access and view content over the network 108.

The network 108 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which the computing devices 104 may access the social networking system 106 and/or communicate with one another.

The social networking system 106 may include one or more servers or other computing devices, any or all of which may include one or more processors and memory storing computer executable instructions to implement the functionality discussed herein attributable to the social networking system 106 or digital platform. The social networking system 106 may enable accounts 102 associated with its users (such as persons or organizations) to interact with the social networking system 106 and with each other via the computing devices 104. The social networking system 106 may, with input from a user, create and store in the social networking system 106 a user account associated with the user. The user account may include demographic information, communication-channel information, financial information and information on personal interests of the user. The social networking system 106 may also, with input from a user, create and store a record of relationships of the user with other users of the social networking system 106, as well as provide services (e.g., posts, comments, photo-sharing, messaging, tagging, mentioning of other users or entities, games, etc.) to facilitate social interaction between or among the accounts 102.

As briefly described above, the social networking system 106 may be configured to provide a first account 102(1) with the ability to create and associate one or more other accounts 102 to an ephemeral collection of content items, herein referred to as a “collaborative story.” For example, a story component 110 of the social networking system 106 may be configured to allow accounts, such as the first account 102(1), to create a collaborative story, in which the multiple accounts, such as the first account 102(1) and a second account 102(2) may post content to a single collection to be viewed by other accounts 102(3)-102(n). Though described primarily as a collective story between the first account 102(1) and the second account 102(2), this is not intended to be so limiting, and the collaborative story may have associated therewith three or more user accounts 102 configured for publishing content in association with the collaborative story.

In the illustrative example of FIG. 1, at operation 112 (indicated by “1”), the social networking system 106 may receive, from a first account 102(1), a request to generate a collaborative story. A collaborative story may include a collection of content items that are provided by user accounts 102 designated as contributors to the collaborative story. For example, the collaborative story may include text and/or media content items, such as images, video, and/or audio, published via the social networking system 106 for consumption by other accounts 102(2)-102(n). In some examples, the collaborative story may be published in a feed of content items that is accessible to other accounts that are connected to one or more collaborator accounts (e.g., first account 102(1), the second account 102(2), etc.). In some examples, the collaborative story may be shared with a select subset of an account's 102 followers, and/or may be removed from being viewed by followers of the account 102 after a certain period of time (e.g., one hour, one day, one week, etc.). A collaborative story may differ from a traditional type of story in that multiple accounts 102 may be associated with a collaborative story, thereby enabling users associated with the multiple accounts 102 to post content items to the collaborative story.

In some examples, the collaborative story may be topic-based, in which the content shared to the collaborative story shares a common theme. For example, the first account 102(1) may choose a topic to which content posted to the collaborative story is related. For example, in response to receiving the request to generate the collaborative story, the social networking system 106 may cause presentation, in association with the first account 102(1), of a user interface element that enables the user associated with the first account 102(1) to input a designated topic, title, description and/or the like associated with the collaborative story. The social networking system 106 may then receive, from the first account 102(1), an indication of a topic (or title, description, etc.) associated with the collaborative story. Non-limiting examples of the topic, title, description include a broad category (e.g., “Triathlon,” “Hiking,” “French Cooking,” “Puppies of the Spokane Dog Park,” etc.), an ongoing occurrence, (e.g., “Running Club,” “Downtown Library Volunteering,” etc.), an event (e.g., “CDA Triathlon 2022,” “National Parks Trip 2021,” “Abby's 25^{th} Birthday,” etc.), and/or the like.

In some examples, the request may include an account identifier (hereinafter referred to as “identifier”) associated with a second account 102(2) that is to be associated with the collaborative story. The account identifier may include a code, a label, or other discrete identifier that is associated with the second account 102(2). That is, the account identifier may uniquely reference the second user account 102(2). In some examples, the social networking system 106 may be configured to suggest one or more account identifiers (e.g., other users) for the first user associated with the first account 102(1) to associate with the collaborative story. For example, in response to receiving the request to generate the collaborative story, the social networking system 106 may cause presentation, via the first account 102(1), of one or more additional accounts 102(2)-102(n) to associate with the collaborative story.

In some examples, the social networking system 106 may suggest the additional account(s) 102 based on a connection type (e.g., follower, followed by, etc.), a relationship between users (e.g., designated as relatives, friends, etc.), a frequency and/or recency of interaction between the first user 102(1) and the additional account(s) 102, and/or the like. In some examples, the social networking system 106 may be configured to identify the additional account(s) 102 to suggest to the first user 102(1) based on the topic, title, and/or description of the collaborative story. That is, the social networking system 106 may analyze communications between user accounts 102 to identify interactions between users that reference the topic, title, description, and/or the like. For example, the social networking system 106 may identify that a topic associated with the collaborative story is a running club. The social networking system 106 may identify one or more additional accounts 102 that are associated with the running club (e.g., associated users check into the running club location, “like” the running club, and/or the like). The social networking system 106 may cause a presentation of the identified additional account(s) 102 for selection to associate with the collaborative story. Additionally or alternatively, the social networking system 106 may cause presentation of a selectable interface to the first account 102(1), in which the first account 102(1) may search for one or more additional accounts 102(2)-102(n) to associate with the collaborative story.

At operation 114 (indicated by a “2”), and in response to receiving the request including the identifier associated with the second account, the social networking system 106 may associate the second account 102(2) with the collaborative story. For example, the social networking system 106 may designate the second account 102(2) as a collaborator of the collaborative story. In other words, the second account 102(2) may contribute to the collaborative story, allowing both the first account 102(1) and the second account 102(2) to share content to the collaborative story.

At operation 116 (indicated by a “3”), a story component 110 of the social networking system 106 may generate the collaborative story between the first account 102(1) and the second account 102(2). In some examples, the first account 102(1) and the second account 102(2) may be designated as collaborators to the collaborative story. In other words, both the first account 102(1) and the second account 102(2) may post content to the collaborative story from their separate accounts.

As an illustrative example, the first account 102(1) may be training for a triathlon. The user associated with the first account 102(1) may wish to post content related to training for the triathlon but may be hesitant to post content alone. Thus, the first account 102(1) may create a triathlon-themed collaborative story with other triathletes training for the same event. The social networking system 106 may receive, from the first account 102(1), a request to generate a collaborative story entitled “Triathlon.” This request may include an account identifier, such as a name (e.g., username, real name, etc.) of a second account 102(2) that is connected with the first account 102(1) via the social networking system 106 and who may also be training for or associated with the triathlon. In response to receiving the request, the social networking system 106 may associate the second account 102(2) to the collaborative story, allowing the second account 102(2) to post content to the collaborative story.

In some examples, the social networking system may provide a selectable icon to the second account 102(2) to share to a story of the second account 102(2). That is, the social networking system 106 may cause presentation of the selectable icon in association with the second account 102(2), the selectable icon enabling a user associated with the second account 102(2) to inform others about the collaborative story. For example, the selectable icon may be associated with a sticker or other interface element that is linked to or otherwise associated with the collaborative story. In such an example, in response to receiving an indication of selection of the selectable icon, the social networking system 106 may cause the collaborative story to be presented in association with an account of a selecting user. In some examples, in response to associating the second account 102(2) with the collaborative story, the social networking system 106 may send, to the second account 102(2), a notification that a user associated with the first account 102(1) associated the second account 102(2) with the collaborative story. The notification may be sent as a direct message to an inbox of the second account 102(2), may be presented as a notification in an activity feed of the second account 102(2), or may be presented on a home page of the second account 102(2), to name a few non-limiting examples. In some examples, the notification may include the selectable icon described above.

At operation 118 (as indicated by a “4”), the social networking system 106 may receive content from at least one of the first account 102(1) or the second account 102(2) to share to the collaborative story. Content may take a variety of forms, such as text and/or media content items, such as images, video, and/or audio. In some examples, the content may be an item of ephemeral content. For example, as described above with respect to the collaborative story, content shared to the collaborative story may be removed from view in association with the collaborative story after a threshold period of time (e.g., one hour, one day, one week, etc.).

Content may additionally or alternatively include a profile or a feed post, a tweet, or a snap. In general, a profile (or feed) post may include text and/or media content items, such as images, video, or audio. The profile post may be published to the social networking system 106 by an account 102, such as the first account 102(1) for consumption by other accounts 102(2)-102(n), and may be viewable by either accounts 102(2)-102(n) for as long as the first account 102(1) is active and/or until the post is deleted by the first account 102(1). In some examples, a profile post shared by the sharing account 102 may be included in respective content feeds of other the accounts 102(2)-102(n) of the social networking system 106 that have “followed” the first account 102(1), are “friends” with the first account 102(1), are connections of the first account 102(1), or are otherwise associated with the account 102(1).

At operation 120 (as indicated by a “5”), the social networking system 106 may cause presentation, via a third account 102(3), of the content in association with the collaborative story. In some examples, the collaborative story may be presented via a display of a computing device associated with the third account 102(3) of the social networking system 106. In some examples, the social networking system 106 may cause presentation of an indication of at least one of the first account 102(1) and/or the second account 102(2) associated with a publisher of a particular content item associated with the collaborative story. For example, the social networking system 106 may receive content from the second account 102(2) that is posted in association with the collaborative story. The social networking system 106 may identify a third user account 102(3) that is connected to at least the first account 102(1) or the second account 102(2) via the social networking system 106. The social networking system 106 may cause presentation, via the third account 102(3) of the content and an indication of a publisher thereof in association with the collaborative story.

Continuing with the illustrative example above, the third account 102(3) may be interested in triathlons, and may be curious about the sport and interested in what training for a triathlon entails. Thus, the third account 102(3) may choose to view the “Triathlon” collaborative story. The social networking system 106 may receive, from the third account 102(3), a request to view the collaborative story (e.g., indication of selection of an indicator associated with the collaborative story). The social networking system 106 may then cause presentation, to the third account 102(3), of the triathlon-related content shared to the collaborative story by the first account 102(1) and/or the second account 102(2). In some examples, the social networking system 106 may additionally cause presentation, along with the content, of an indication of the account 102 that posted the content, such as a username associated with the account 102. In this way, the social networking system 106 may make it clear to the viewing user (e.g., third account 102(3)) who published the content.

In some examples, a user associated with the third account 102(3) may request to associate with (e.g., access, follow, etc.) the collaborative story. For example, the user associated with the third account 102(3) may wish to follow the collaborative story, allowing the third account 102(3) to view content and updates posted in association with the collaborative story. Associating with the collaborative story may result in content from the collaborative story being presented to the third account 102(3) in a variety of ways. In some examples, in response to receiving a request from the third account 102(3) to associate with the collaborative story, the social networking system 106 may cause presentation, to the third account 102(3), an indication of the collaborative story to a feed of the third account 102(3). In response to receiving an indication that the third account 102(3) has selected the indication of the collaborative story, the social networking system 106 may cause presentation of the content to the third account 102(3). Additionally or alternatively, associating with the collaborative story may allow the third account 102(3) to access the collaborative story from a profile associated with the first account 102(1) and/or the second account 102(2). For example, in response to receiving content from at least one of the first account or the second account to share to the collaborative story, the social networking system 106 may cause presentation, on a profile associated with at least the first account 102(1) or the second account 102(2), of an icon indicating that the first account 102(1) and/or the second account 102(2) is a collaborator in a collaborative story. In response to receiving an indication that the third account 102(3) has selected the icon, the social networking system 106 may cause present, to the third account, of an option to view the collaborative story.

In some examples, the first account 102(1) and/or the second account 102(2) may post content to a traditional story, as described above, which may be separate from the collaborative story. Additionally or alternatively, the first account 102(1) and/or the second account 102(2) may be associated with a second collaborative story different from the first collaborative story. For example, the first account 102(1) may be a collaborator in multiple collaborative stories. Thus, in response to selection of the icon by the third account 102(3), the social networking system 106 may cause presentation, to the third account 102(3), of a name of the one or more stories, either collaborative or traditional, that the first account 102(1) is associated with. In response to selection of the name of the story by the third account 102(3), the social networking system 106 may cause presentation, to the third account 102(3), of content associated with the selected story.

In some examples, the user associated with the third account 102(3) may request to contribute to the collaborative story as a contributor. Thus, in some examples, the social networking system 106 may receive, from the third account 102(3), a request to join the collaborative story as a collaborator. In response to the request, the social networking system 106 may then send, to the first account 102(1) and/or the second account 102(2), an option to accept or deny the request. In various examples, the option to accept or deny the request may be sent to the “owner,” “initiator,” or “administrative” account (e.g., the first account 102(1)) that is associated with the collaborative story. In some examples, the option to accept or deny the request may be sent to all or a portion of the accounts designated as collaborators in the collaborative story. In response to receiving an indication from the first account 102(1) and/or the second account 102(2) that one or both of the first account 102(1) and/or the second account 102(2) have denied the request, the social networking system 106 may send, to the third account 102(3) a notification that the third account 102(3) has not been designated as a collaborator of the collaborative story. Alternatively, in response to receiving an indication from the first account 102(1) and/or the second account 102(2) that the first account 102(1) and/or the second account 102(2) have approved the request, the social networking system 106 may designate the third account 102(3) as a collaborator to the collaborative story. Additionally, in some examples, the social networking system 106 may send, to the third account 102(3), a notification that the third account 102(3) has been designated as a collaborator to the collaborative story.

Similar to the first account 102(1) and the second account 102(2), the third account 102(3) may post content to the collaborative story. For example, in response to designating the third account 102(3) as a collaborator to the collaborative story, the social networking system 106 may receive content from the third account 102(3) to share to the collaborative story. Similar to the content shared by the first account 102(1) and/or the second account 102(2), the content shared by the third account 102(3) may include text and/or media content items, such as images, video, and/or audio, and may be an item of ephemeral content.

In some examples, a user associated with an account designated as a collaborator to the collaborative story may wish to dissociate from the collaborative story, thus no longer allowing the collaborator to share content to the collaborative story. For example, the social networking system 106 may receive, from the second account 102(2), a request to dissociate from the collaborative story. In response to the request, the social networking system 106 may then remove the account identifier associated with the second account 102(2) from the collaborative story. In some examples, in response to dissociating the second account 102(2), the social networking system 106 may permit the second account 102(2) access to the collaborative story, without enabling the publication of content to the collaborative story in association with second account 102(2) (e.g., second account 102(2) may be designated as a “follower” and not a “contributor” of the collaborative story). In other examples, in response to removing the identifier associated with the second account 102(2) from the collaborative story, the social networking system 106 may refrain from sharing the content with the second account 102(2).

In some examples, the social networking system 106 may configure the collaborative story to enable viewing users to comment on content posted in association therewith. That is, the user associated with the third account 102(3) may publish a comment associated with the collaborative story and/or a content item posted in association therewith. Additionally, the collaborative story may be configured to enable users associated with the first account 102(1) and the second account 102(2) (e.g., the collaborators) to respond to the comments published by others. In some examples, the comment and/or the response may be presented in a communication interface that is associated with the content (e.g., a particular post) and/or the collaborative story in general. The communication interface may be accessible to the collaborators of the collaborative story (e.g., first account 102(1), the second account 102(2), etc.), other users associated with or otherwise connected to the collaborative story (e.g., followers, etc.), and/or viewers of the collaborative story (e.g., other accounts 102 with permissions to view the collaborative story. Continuing the illustrative example above, the first account 102(1) may post a video of a person on a bicycle in association with the “Triathlon” collaborative story. In response to viewing the video, the user associated with the third account 102(3) may comment on the video, such as asking a question about the bike in the video. The first account 102(1) and/or the second account 102(2) may respond to the comment published by the user associated with the third account 102(3). The response and/or the comment may be presented in the communication interface, which may be accessible to additional accounts 102 viewing the collaborative story. In this way, not only may the first account 102(1) and the second account 102(2) engage with one another in creating and posting content to the collaborative story, the first account 102(1) and/or the second account 102(2) may engage with an audience viewing the collaborative story.

In some examples, the social networking system 106 may provide privacy features to the accounts 102. In particular examples, one or more objects (e.g., content or other types of objects) of the computing system 100 may be associated with one or more privacy settings. The one or more objects may be stored on or otherwise associated with any suitable computing system or application, such as, for example, the social networking system 106, a client system, a third-party system, a social networking application, a messaging application, a photo-sharing application, or any other suitable computing system or application. Although the examples discussed herein are in the context of an online social network, these privacy settings may be applied to any other suitable computing system. Privacy settings (or “access settings”) for an object or item of content may be stored in any suitable manner, such as, for example, in association with the object, in an index on an authorization server, in another suitable manner, or any suitable combination thereof. A privacy setting for an object may specify how the object (or particular information associated with the object) can be accessed, stored, or otherwise used (e.g., viewed, shared, modified, copied, executed, surfaced, or identified) within the online social network. When privacy settings for an object allow a particular account or other entity to access that object, the object may be described as being “visible” with respect to that account or other entity. As an example, and not by way of limitation, an account of the social networking system 106 may specify privacy settings for an account-profile page that identify a set of accounts that may access work-experience information on the account-profile page, thus excluding other accounts from accessing that information.

In particular examples, privacy settings for an object may specify a “blocked list” and/or a “restricted list” of accounts or other entities that should not be allowed to access certain information associated with the object. In particular examples, the blocked list may include third-party entities. The blocked list or restricted list may specify one or more accounts or entities for which an object is not visible. As an example, and not by way of limitation, an account may specify a set of accounts who may not access photo albums associated with the account, thus excluding those accounts from accessing the photo albums (while also possibly allowing certain accounts not within the specified set of accounts to access the photo albums). In particular examples, privacy settings may be associated with particular social-graph elements. Privacy settings of a social-graph element, such as a node or an edge, may specify how the social-graph element, information associated with the social-graph element, or objects associated with the social-graph element can be accessed using the online social network. As an example, and not by way of limitation, a particular concept node corresponding to a particular photo may have a privacy setting specifying that the photo may be accessed only by accounts tagged in the photo and friends of the accounts tagged in the photo. In particular examples, privacy settings may allow accounts to opt in to or opt out of having their content, information, or actions stored/logged by the social networking system 106 or shared with other systems (e.g., a third-party system). Although this disclosure describes using particular privacy settings in a particular manner, this disclosure contemplates using any suitable privacy settings in any suitable manner.

In particular examples, privacy settings may be based on one or more nodes or edges of a social graph. A privacy setting may be specified for one or more edges or edge-types of the social graph, or with respect to one or more nodes or node-types of the social graph. The privacy settings applied to a particular edge connecting two nodes may control whether the relationship between the two entities corresponding to the nodes is visible to other accounts of the online social network. Similarly, the privacy settings applied to a particular node may control whether the account or concept corresponding to the node is visible to other accounts of the online social network. As an example, and not by way of limitation, the first account 102(1) may share an object to the social networking system 106. The object may be associated with a concept node connected to an account node of the first account 102(1) by an edge. The first account 102(1) may specify privacy settings that apply to a particular edge connecting to the concept node of the object or may specify privacy settings that apply to all edges connecting to the concept node. As another example and not by way of limitation, the first account 102(1) may share a set of objects of a particular object-type (e.g., a set of images). The first account 102(1) may specify privacy settings with respect to all objects associated with the first account 102(1) of that particular object-type as having a particular privacy setting (e.g., specifying that all images posted by the first account 102(1) are visible only to friends of the first account 102(1) and/or accounts tagged in the images).

In particular examples, the social networking system 106 may present a “privacy wizard” (e.g., within a webpage, a module, one or more dialog boxes, or any other suitable interface) to the first account 102(1) to assist the first account 102(1) in specifying one or more privacy settings. The privacy wizard may display instructions, suitable privacy-related information, current privacy settings, one or more input fields for accepting one or more inputs from the first account 102(1) specifying a change or confirmation of privacy settings, or any suitable combination thereof. In particular examples, the social networking system 106 may offer a “dashboard” functionality to the first account 102(1) that may display, to the first account 102(1), current privacy settings of the first account 102(1). The dashboard functionality may be displayed to the first account 102(1) at any appropriate time (e.g., following an input from the first account 102(1) summoning the dashboard functionality, following the occurrence of a particular event or trigger action). The dashboard functionality may allow the first account 102(1) to modify one or more of the first account 102(1)'s current privacy settings at any time, in any suitable manner (e.g., redirecting the first account 102(1) to the privacy wizard).

Privacy settings associated with an object may specify any suitable granularity of permitted access or denial of access, including the “restrict” functionality described herein. As an example and not by way of limitation, access or denial of access may be specified for particular accounts (e.g., only me, my roommates, my boss), accounts within a particular degree-of-separation (e.g., friends, friends-of-friends), account groups (e.g., the gaming club, my family), account networks (e.g., employees of particular employers, students or alumni of particular university), all accounts (“public”), no accounts (“private”), accounts of third-party systems, particular applications (e.g., third-party applications, external websites), other suitable entities, or any suitable combination thereof. Although this disclosure describes particular granularities of permitted access or denial of access, this disclosure contemplates any suitable granularities of permitted access or denial of access.

In particular examples, one or more servers may be authorization/privacy servers for enforcing privacy settings. In response to a request from an account (or other entity) for a particular object stored in a data store, the social networking system 106 may send a request to the data store for the object. The request may identify the account associated with the request and the object may be sent only to the account (or a client system of the account) if the authorization server determines that the account is authorized to access the object based on the privacy settings associated with the object. If the requesting account is not authorized to access the object, the authorization server may prevent the requested object from being retrieved from the data store or may prevent the requested object from being sent to the account. In the search-query context, an object may be provided as a search result only if the querying account is authorized to access the object, e.g., if the privacy settings for the object allow it to be surfaced to, discovered by, or otherwise visible to the querying account. In particular examples, an object may represent content that is visible to an account through a newsfeed of the account. As an example, and not by way of limitation, one or more objects may be visible to an account's “Trending” page. In particular examples, an object may correspond to a particular account. The object may be content associated with the particular account or may be the particular account's account or information stored on the social networking system 106, or other computing system. As an example, and not by way of limitation, a first account 102(1) may view one or more second accounts of an online social network through a “People You May Know” function of the online social network, or by viewing a list of friends of the first account 102(1). As an example, and not by way of limitation, a first account 102(1) may specify that they do not wish to see objects associated with a particular second account in their newsfeed or friends list. If the privacy settings for the object do not allow it to be surfaced to, discovered by, or visible to the account, the object may be excluded from the search results. Although this disclosure describes enforcing privacy settings in a particular manner, this disclosure contemplates enforcing privacy settings in any suitable manner.

In particular examples, different objects of the same type associated with an account may have different privacy settings. Different types of objects associated with an account may have different types of privacy settings. As an example, and not by way of limitation, a first account 102(1) may specify that the first account 102(1)'s status updates are public, but any images shared by the first account 102(1) are visible only to the first account 102(1)'s friends on the online social network. As another example and not by way of limitation, an account may specify different privacy settings for different types of entities, such as individual accounts, friends-of-friends, followers, account groups, or corporate entities. As another example and not by way of limitation, a first account 102(1) may specify a group of accounts that may view videos posted by the first account 102(1), while keeping the videos from being visible to the first account 102(1)'s employer. In particular examples, different privacy settings may be provided for different account groups or account demographics. As an example, and not by way of limitation, a first account 102(1) may specify that other account who attend the same university as the first account 102(1) may view the first account 102(1)'s pictures, but that other account who are family members of the first account 102(1) may not view those same pictures.

In particular examples, the social networking system 106 may provide one or more default privacy settings for each object of a particular object-type. A privacy setting for an object that is set to a default may be changed by an account associated with that object. As an example, and not by way of limitation, all images posted by a first account 102(1) may have a default privacy setting of being visible only to friends of the first account 102(1) and, for a particular image, the first account 102(1) may change the privacy setting for the image to be visible to friends and friends-of-friends.

In particular examples, privacy settings may allow a first account 102(1) to specify (e.g., by opting out, by not opting in) whether the social networking system 106 may receive, collect, log, or store particular objects or information associated with the account for any purpose. In particular examples, privacy settings may allow the first account 102(1) to specify whether particular applications or processes may access, store, or use particular objects or information associated with the account. The privacy settings may allow the first account 102(1) to opt in or opt out of having objects or information accessed, stored, or used by specific applications or processes. The social networking system 106 may access such information in order to provide a particular function or service to the first account 102(1), without the social networking system 106 having access to that information for any other purposes. Before accessing, storing, or using such objects or information, the social networking system 106 may prompt the account to provide privacy settings specifying which applications or processes, if any, may access, store, or use the object or information prior to allowing any such action. As an example, and not by way of limitation, a first account 102(1) may transmit a message to a second account via an application related to the online social network (e.g., a messaging app), and may specify privacy settings that such messages should not be stored by the social networking system 106.

In particular examples, an account may specify whether particular types of objects or information associated with the first account 102(1) may be accessed, stored, or used by the social networking system 106. As an example, and not by way of limitation, the first account 102(1) may specify that images sent by the first account 102(1) through the social networking system 106 may not be stored by the social networking system 106. As another example and not by way of limitation, a first account 102(1) may specify that messages sent from the first account 102(1) to a particular second account may not be stored by the social networking system 106. As yet another example and not by way of limitation, a first account 102(1) may specify that all objects sent via a particular application may be saved by the social networking system 106.

In particular examples, privacy settings may allow a first account 102(1) to specify whether particular objects or information associated with the first account 102(1) may be accessed from particular client systems or third-party systems. The privacy settings may allow the first account 102(1) to opt in or opt out of having objects or information accessed from a particular device (e.g., the phone book on an account's smart phone), from a particular application (e.g., a messaging app), or from a particular system (e.g., an email server). The social networking system 106 may provide default privacy settings with respect to each device, system, or application, and/or the first account 102(1) may be prompted to specify a particular privacy setting for each context. As an example, and not by way of limitation, the first account 102(1) may utilize a location-services feature of the social networking system 106 to provide recommendations for restaurants or other places in proximity to the account. The first account 102(1)'s default privacy settings may specify that the social networking system 106 may use location information provided from a client device of the first account 102(1) to provide the location-based services, but that the social networking system 106 may not store the location information of the first account 102(1) or provide it to any third-party system. The first account 102(1) may then update the privacy settings to allow location information to be used by a third-party image-sharing application in order to geo-tag photos.

### Privacy Settings for Mood, Emotion, or Sentiment Information

In particular examples, privacy settings may allow an account to specify whether current, past, or projected mood, emotion, or sentiment information associated with the account may be determined, and whether particular applications or processes may access, store, or use such information. The privacy settings may allow accounts to opt in or opt out of having mood, emotion, or sentiment information accessed, stored, or used by specific applications or processes. The social networking system 106 may predict or determine a mood, emotion, or sentiment associated with an account based on, for example, inputs provided by the account and interactions with particular objects, such as pages or content viewed by the account, posts or other content uploaded by the account, and interactions with other content of the online social network. In particular examples, the social networking system 106 may use an account's previous activities and calculated moods, emotions, or sentiments to determine a present mood, emotion, or sentiment. An account who wishes to enable this functionality may indicate in their privacy settings that they opt into the social networking system 106 receiving the inputs necessary to determine the mood, emotion, or sentiment. As an example, and not by way of limitation, the social networking system 106 may determine that a default privacy setting is to not receive any information necessary for determining mood, emotion, or sentiment until there is an express indication from an account that the social networking system 106 may do so. By contrast, if an account does not opt in to the social networking system 106 receiving these inputs (or affirmatively opts out of the social networking system 106 receiving these inputs), the social networking system 106 may be prevented from receiving, collecting, logging, or storing these inputs or any information associated with these inputs. In particular examples, the social networking system 106 may use the predicted mood, emotion, or sentiment to provide recommendations or advertisements to the account. In particular examples, if an account desires to make use of this function for specific purposes or applications, additional privacy settings may be specified by the account to opt in to using the mood, emotion, or sentiment information for the specific purposes or applications. As an example, and not by way of limitation, the social networking system 106 may use the account's mood, emotion, or sentiment to provide newsfeed items, pages, friends, or advertisements to an account. The account may specify in their privacy settings that the social networking system 106 may determine the account's mood, emotion, or sentiment. The account may then be asked to provide additional privacy settings to indicate the purposes for which the account's mood, emotion, or sentiment may be used. The account may indicate that the social networking system 106 may use his or her mood, emotion, or sentiment to provide newsfeed content and recommend pages, but not for recommending friends or advertisements. The social networking system 106 may then only provide newsfeed content or pages based on account mood, emotion, or sentiment, and may not use that information for any other purpose, even if not expressly prohibited by the privacy settings.

### Privacy Settings for Ephemeral Sharing

In particular examples, privacy settings may allow an account to engage in the ephemeral sharing of objects on the online social network. Ephemeral sharing refers to the sharing of objects (e.g., posts, photos) or information for a finite period of time. Access or denial of access to the objects or information may be specified by time or date. As an example, and not by way of limitation, an account may specify that a particular image uploaded by the account is visible to the account's friends for the next week, after which time the image may no longer be accessible to other accounts. As another example and not by way of limitation, a company may post content related to a product release ahead of the official launch and specify that the content may not be visible to other accounts until after the product launch.

In particular examples, for particular objects or information having privacy settings specifying that they are ephemeral, the social networking system 106 may be restricted in its access, storage, or use of the objects or information. The social networking system 106 may temporarily access, store, or use these particular objects or information in order to facilitate particular actions of an account associated with the objects or information, and may subsequently delete the objects or information, as specified by the respective privacy settings. As an example, and not by way of limitation, a first account 102(1) may transmit a message to a second account, and the social networking system 106 may temporarily store the message in a data store until the second account has viewed or downloaded the message, at which point the social networking system 106 may delete the message from the data store. As another example and not by way of limitation, continuing with the prior example, the message may be stored for a specified period of time (e.g., 2 weeks), after which point the social networking system 106 may delete the message from the data store.

### Privacy Settings for Account-Authentication and Experience-Personalization Information

In particular examples, the social networking system 106 may have functionalities that may use, as inputs, personal or biometric information of a user associated with an account for user-authentication or experience-personalization purposes. An account may opt to make use of these functionalities to enhance their experience on the online social network. As an example, and not by way of limitation, an account may provide personal or biometric information to the social networking system 106. A privacy setting associated with an account may specify that such information may be used only for particular processes, such as authentication, and further specify that such information may not be shared with any third-party system or used for other processes or applications associated with the social networking system 106. As another example and not by way of limitation, the social networking system 106 may provide a functionality for an account to provide voice-print recordings to the online social network. As an example, and not by way of limitation, if an account wishes to utilize this function of the online social network, the user associated with the account may provide a voice recording of his or her own voice to provide a status update on the online social network. The recording of the voice-input may be compared to a voice print of the user associated with the account to determine what words were spoken by the account. The account's privacy setting may specify that such voice recording may be used only for voice-input purposes (e.g., to authenticate the account, to send voice messages, to improve voice recognition in order to use voice-operated features of the online social network), and further specify that such voice recording may not be shared with any third-party system or used by other processes or applications associated with the social networking system 106. As another example and not by way of limitation, the social networking system 106 may provide a functionality for an account to provide a reference image (e.g., a facial profile, a retinal scan) to the online social network. The online social network may compare the reference image against a later-received image input (e.g., to authenticate the account, to tag the account in photos). The account's privacy setting may specify that such voice recording may be used only for a limited purpose (e.g., authentication, tagging the account in photos), and further specify that such voice recording may not be shared with any third-party system or used by other processes or applications associated with the social networking system 106.

### Account-Initiated Changes to Privacy Settings

In particular examples, changes to privacy settings may take effect retroactively, affecting the visibility of objects and content shared prior to the change. As an example, and not by way of limitation, a first account 102(1) may share a first image and specify that the first image is to be public to all other accounts. At a later time, the first account 102(1) may specify that any images shared by the first account 102(1) should be made visible only to a group associated with the first account 102(1). The social networking system 106 may determine that this privacy setting also applies to the first image and make the first image visible only to the first account's 102(1) group. In particular examples, the change in privacy settings may take effect only going forward. Continuing the example above, if the first account 102(1) changes privacy settings and then shares a second image, the second image may be visible only to the first account's 102(1) group, but the first image may remain visible to all accounts. In particular examples, in response to an account action to change a privacy setting, the social networking system 106 may further prompt the account to indicate whether the account wants to apply the changes to the privacy setting retroactively. In particular examples, an account change to privacy settings may be a one-off change specific to one object. In particular examples, an account change to privacy may be a global change for all objects associated with the account.

In particular examples, the social networking system 106 may determine that a first account 102(1) may want to change one or more privacy settings in response to a trigger action associated with the first account 102(1). The trigger action may be any suitable action on the online social network. As an example, and not by way of limitation, a trigger action may be a change in the relationship between a first and second account of the online social network (e.g., “un-friending” an account, changing the relationship status between the accounts). In particular examples, in response to determining that a trigger action has occurred, the social networking system 106 may prompt the first account 102(1) to change the privacy settings regarding the visibility of objects associated with the first account 102(1). The prompt may redirect the first account 102(1) to a workflow process for editing privacy settings with respect to one or more entities associated with the trigger action. The privacy settings associated with the first account 102(1) may be changed only in response to an explicit input from the first account 102(1) and may not be changed without the approval of the first account 102(1). As an example and not by way of limitation, the workflow process may include providing the first account 102(1) with the current privacy settings with respect to the second account or to a group of accounts (e.g., un-tagging the first account 102(1) or second account from particular objects, changing the visibility of particular objects with respect to the second account or group of accounts), and receiving an indication from the first account 102(1) to change the privacy settings based on any of the methods described herein, or to keep the existing privacy settings.

In particular examples, an account may need to provide verification of a privacy setting before allowing the account to perform particular actions on the online social network, or to provide verification before changing a particular privacy setting. When performing particular actions or changing a particular privacy setting, a prompt may be presented to the account to remind the account of his or her current privacy settings and to ask the account to verify the privacy settings with respect to the particular action. Furthermore, an account may need to provide confirmation, double-confirmation, authentication, or other suitable types of verification before proceeding with the particular action, and the action may not be complete until such verification is provided. As an example, and not by way of limitation, an account's default privacy settings may indicate that a person's relationship status is visible to all accounts (i.e., “public”). However, if the account changes his or her relationship status, the social networking system 106 may determine that such action may be sensitive and may prompt the account to confirm that his or her relationship status should remain public before proceeding. As another example and not by way of limitation, an account's privacy settings may specify that the account's posts are visible only to friends of the account. However, if the account changes the privacy setting for his or her posts to being public, the social networking system 106 may prompt the accounts with a reminder of the account's current privacy settings of posts being visible only to friends, and a warning that this change will make all of the account's past posts visible to the public. The account may then be required to provide a second verification, input authentication credentials, or provide other types of verification before proceeding with the change in privacy settings. In particular examples, an account may need to provide verification of a privacy setting on a periodic basis. A prompt or reminder may be periodically sent to the account based either on time elapsed or a number of account actions. As an example, and not by way of limitation, the social networking system 106 may send a reminder to the account to confirm his or her privacy settings every six months or after every ten photo posts. In particular examples, privacy settings may also allow accounts to control access to the objects or information on a per-request basis. As an example, and not by way of limitation, the social networking system 106 may notify the account whenever a third-party system attempts to access information associated with the account and require the account to provide verification that access should be allowed before proceeding.

In some examples, causing presentation of the collaborative story to the third account 102(3) may be based at least in part on privacy settings of the first account 102(1) and/or the second account 102(2). In some examples, the social networking system 106 may determine that the first account 102(1) and the second account are public accounts. Thus, the social networking system 106 may cause presentation of the collaborative story with any third account 102(3), regardless of whether the third account 102(3) is connected with the first account 102(1) and/or the second account 102(2) (e.g., is a follower, friend, etc.) of the first account 102(1) and/or the second account 102(1).

Alternatively, the social networking system 106 may determine that first account 102(1) and the second account 102(2) are private accounts. In such examples, the social networking system 106 may render the collaborative story available for view to accounts 102 that are connected to at least one of the first account 102(1) or the second account 102(2) via the social networking system. In response to determining that the third account 102(3) is connected to the first account 102(1) and/or the second account 102(2), the social networking system 106 may cause presentation of the collaborative story to the third account 102(3). In some examples, in response to determining that the third account 102(3) is connected to the first account 102(1) but not the second account 102(2), the social networking system 106 may withhold at least a portion of the data posted in association with the collaborative story. That is, the social networking system 106 may render available for view data associated with accounts to which the viewing user is connected but may withhold data associated with accounts with which the viewing user is not connected.

In some examples, the social networking system 106 may determine that the first account 102(1) is a public account and the second account 102(2) is a private account. In response to receiving a request, from the third account 102(3), to view the collaborative story, the social networking system 106 may cause presentation of the collaborative story to the third account 102(3). In such examples, associating a single public account with the collaborative story may render the collaborative story and content published by each collaborator public. That is, based on a determination that an account associated with the collaborative story includes a public account, the social networking system 106 modifies the permissions associated with the collaborative story to a public permissions setting.

### Example User Interfaces

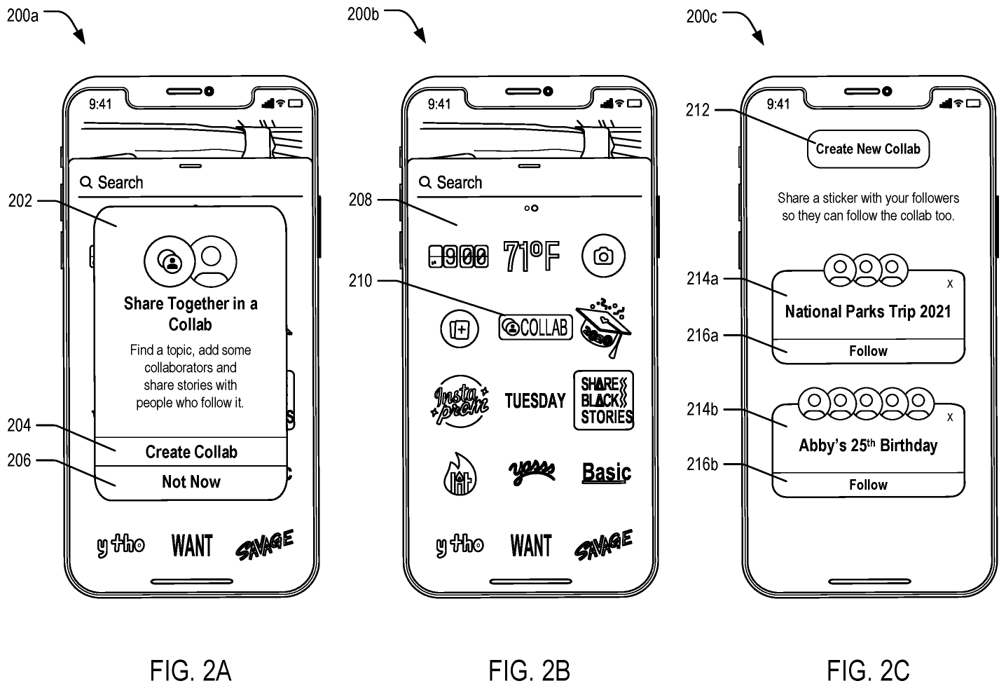

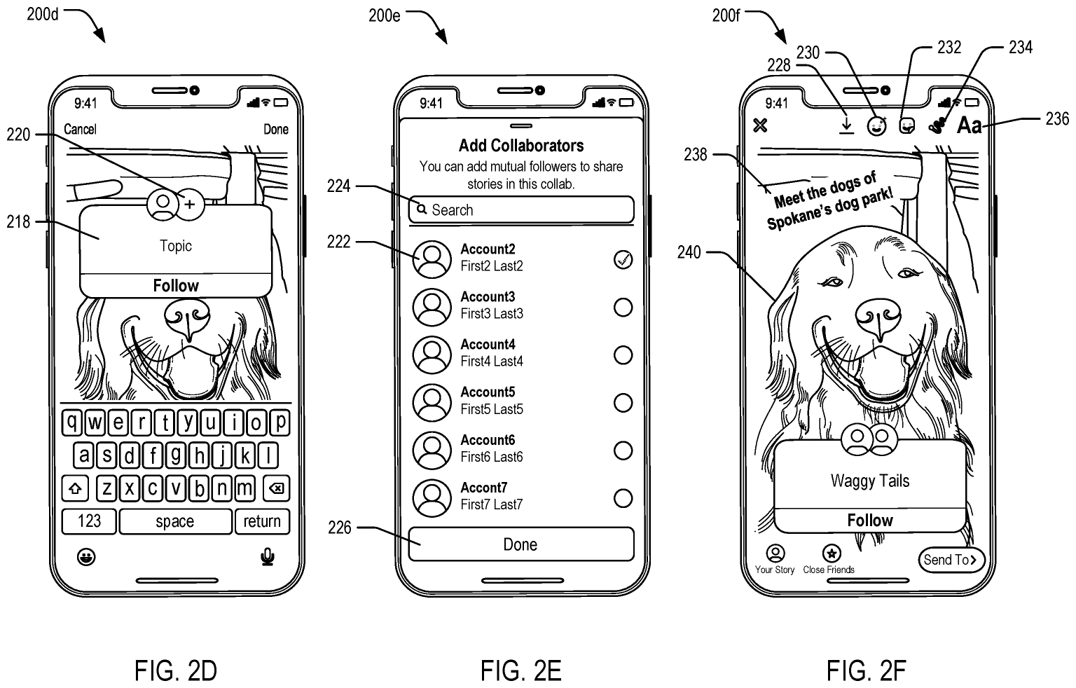

FIG. 2A-FIG. 9B are schematic views showing example user interfaces that are usable to implement the techniques described herein for creating and interacting with collaborative stories. The interfaces and/or the notifications may be generated by a computing device of a social networking system (e.g., social networking system 106) and transmitted to one or more user computing devices (e.g., computing devices 104) for presentation, and/or the interfaces may be generated by the one or more user computing devices based at least in part on instructions received from the social networking system 106. As discussed above, the interfaces described in this section may, but need not, be implemented in the context of the computing system 100.

FIGS. 2A-2F illustrate example interfaces usable to create a collaborative story. FIG. 2A illustrates an example interface 200a that includes a notification prompting the first account 102(1) to create a collaborative story. For example, the social networking system 106 may cause presentation, to the first account 102(1), of a notification 202 including selectable controls 204 and 206. In response to receiving an indication of selection of control 204 by the user associated with the first account 102(1), the social networking system 106 may receive a request to create a collaborative story. In various examples, in response to receiving the request, the social networking system 106 may cause presentation of interface 200c via the first account 102(1), as described in reference to FIG. 2C. Alternatively, the social networking system 106 may receive, from the first account 102(1), an indication of selection of the control 206. In response to receiving the indication of selection 206, the social networking system 106 may cause presentation, in association with the first account 102(1), of example interface 200b, as described in reference to FIG. 2B.

In some examples, as illustrated by example interface 200b, the first account 102(1) may create a collaborative story via a user interface element, otherwise referred to herein as a “sticker.” For example, the social networking system 106 may receive, from the first account 102(1), an indication to access a sticker tray 208. The sticker tray 208 may include, for example, a selectable collaborative story sticker 210. In response to receiving an indication that the first account 102(1) has selected the sticker 210, the social networking system 106 may cause presentation of interface 200c to the first account 102(1), as described in FIG. 2C.

FIG. 2C illustrates an example interface 200c for creating a collaborative story. In response to receiving an indication of a selection of the control 204 and/or the sticker 210 by the first account 102(1), the social networking system 106 may cause presentation of interface 200c to the first account 102(1). In some examples, the interface 200c may include a selectable icon 212 which, in response to selection, may cause presentation of interface 200d, described in reference to FIG. 2D.

In some examples, interface 200c may include existing collaborative stories, such as 212a and 214a, as recommended collaborative stories. For example, the social networking system 106 may cause presentation, to the first account 102(1), of one or more recommended collaborative stories that the social networking system 106 predicts the first account 102(1) may be interested in following. For example, the social networking system 106 may identify a second collaborative story having one or more contributing accounts 102(2)-102(n) that are connected with the first account 102(1) on the social networking system 106. The social networking system 106 may then determine a number of the contributing accounts 102(2)-102(n) to the second collaborative story that are connected (e.g., “friends,” “followers,” etc.) with the first account 102(1). Based at least in part on the number of contributing accounts 102(2)-102(n) that are connected to the first account 102(1) being greater than a threshold number (e.g., 1, 5, 10, etc.), the social networking system 106 may cause presentation, to the first account 102(1), of the second collaborative story as a recommended collaborative story. In some examples, the social networking system 106 may cause presentation of one or more recommended collaborative stories, such as 212a and 212b.

In other examples, the social networking system 106 may identify a recommended collaborative story based on one or more connections of the first account 102(1) being associated with or otherwise following a collaborative story. For example, the social networking system 106 may determine a number of accounts 102(2)-102(n) following a second collaborative story that are connected with the first account 102(1). Based at least in part on the number of accounts 102(2)-102(n) following the second collaborative story being greater than a threshold number of accounts 102(2)-102(n) (e.g., 1, 5, 10, 20, etc.), the social networking system 106 may recommend, to the first account 102(1), the second collaborative story as a recommended collaborative story.

In some examples, the social networking system 106 may further include selectable controls 212b and 214b which, In response to selection, may associate the first account 102(1) with the recommended account, such that the social networking system 106 may cause presentation of content associated with the recommended collaborative story to the first account 102(1).

As discussed above, in response to receiving an indication of selection of the control 204, the sticker 210, and/or the selectable icon 212, the social networking system 106 may cause presentation of interface 200d of FIG. 2D. Interface 200d includes a selectable text box 218 via which the user associated with the first account 102(1) input a specific topic, theme, description, title, and/or the like associated with the new collaborative story. In some examples, the social networking system 106 may receive, from the first account 102(1), input including a topic, theme, description, title, and/or the like associated with the collaborative story and may associate the input with the new collaborative story. Additionally, in some examples, the interface 200d may include selectable icon 220 which, in response to selection, may cause presentation of example interface 200e for associating a second account 102(2) with the collaborative story, as described in FIG. 2E.

In various examples, in response to receiving an indication of selection of the icon 220, the social networking system 106 may identify one or more other user accounts 102(2)-102(n) configured to be associated with the collaborative story. In some examples, the social networking system 106 may identify the one or more other accounts 102(2)-102(n) based on a connection with the first account 102(1). In some examples, the social networking system 106 may identify the other accounts 102(2)-102(n) based on interactions with the first account 102(1). The identification and/or ranking of the other accounts 102(2)-102(n) may be based on a recency of interaction, a frequency of interaction, a content associated with an interaction (e.g., a topic of discussion, common words used, etc.), and/or other interaction data associated with interactions between the other account(s) 102(2)-102(n) and the first account 102(1). In response to identifying the other account(s) 102(2)-102(n), the social networking system 106 may cause presentation of indicators associated with the one or more other accounts 102(2)-102(n) via the interface 200e. In various examples, the interface 200e may include a list (ranked or not) of one or more suggested user accounts to be associated with the new collaborative story. Additionally or alternatively, the social networking system 106 may cause presentation of a selectable search box 224 in which the first account 102(1) may search for additional accounts 102(3)-102(n) to associate with the collaborative story. In the illustrative example of FIG. 2E, the first account 102(1) selects Account2, a second account 102(2), to add to the collaborative story as a collaborator.

In some examples, the example interface 200e may include a selectable icon 226 which, in response to selection, may associate the second account 102(2) with the collaborative story. In response to associating the second account 102(2) with the collaborative story, the social networking system 106 may cause presentation, to the first account 102(1), of example interface 200f, as illustrated in FIG. 2F. The example interface 200f may include selectable controls 228, 230, 232, 235, and 236 which may allow the first account 102(1) to add, remove, and/or edit content to be posted to the collaborative story. In the current example, the first account 102(1) has added text 238 to an image 240 to be posted to the collaborative story “Waggy Tails.”

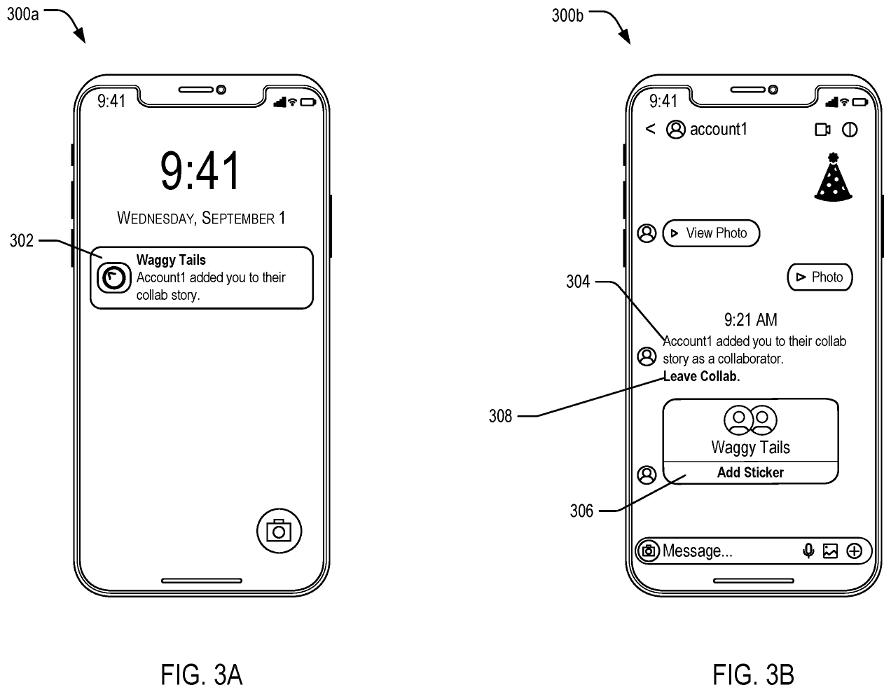

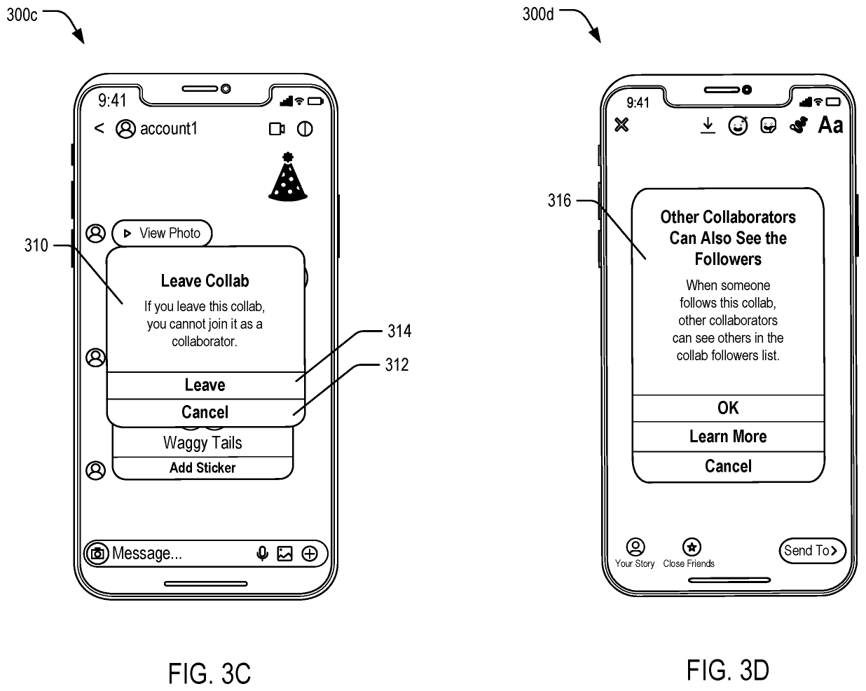

FIGS. 3A-3D illustrate example interfaces usable to provide a notification that an account has been associated with a collaborative story. For example, in response to associating the second account 102(2) with the collaborative story, the social networking system 106 may cause presentation, via the second account 102(2), of a notification alerting the second account 102(2) that they have been added as a collaborator. In some examples, as illustrated by interface 300a in FIG. 3A, the social networking system 106 may send a notification 302 to a computing device associated with the second account 102(2). Additionally or alternatively, as illustrated by example interface 300b in FIG. 3B, the social networking system 106 may send a notification 304 as a direct message to an inbox of the second account 102(2). For example, the notification 304 may include selectable icon 306 in which, in response to selection by the second account 102(2), may cause the social networking system 106 to cause presentation, to the second account 102(2), interface 300d, as described in FIG. 3D. In some examples, the notification 304 may include selectable text 308 in which, in response to selection by the second account 102(2), may enable the user associated with the second account 102(2) to dissociate from the collaborative story. In various examples, in response to receiving an indication of selection of the selectable text 308, the social networking system 106 may remove an association of an account identifier of the second account 102(2) from the collaborative story. In some examples, in response to receiving the indication of selection of the selectable text 308, the social networking system 106 may cause presentation of example interface 300c, as described in FIG. 3C.

FIG. 3C illustrates example interface 300c usable for the second account 102(2) to dissociate from the collaborative story. For example, in response to receiving an indication of selection of a selectable text 308, the social networking system 106 may cause presentation, to the second account 102(2), of a notification 310. The notification may include selectable controls 312 and/or 314. Selection of control 314 (illustrated as “leave”) may cause the social networking system 106 to remove the identifier associated with the second account 102(2) from the collaborative story, thus removing the second account 102(2) as a collaborator to the collaborative story. Conversely, in response to selection of control 312 (illustrated as “cancel”), the social networking system 106 may maintain the association between the account identifier of the second account 102(2) and the collaborative story.

In some examples, in response to associating the second account 102(2) with the collaborative story, the social networking system 106 may cause presentation of a notification 316 in association with the second account 102(2), the notification 316 informing the user associated with the second account 102(2) that any content shared in association with the collaborative story may be accessible to a range of viewers. For example, if the second account 102(2) is a private account, but the first account 102(1) is a public account (e.g., viewable to any users of the social networking system 106), content posted in association with the collaborative story may be accessible to any users of the social networking system 106 (e.g., collaborative story is public).

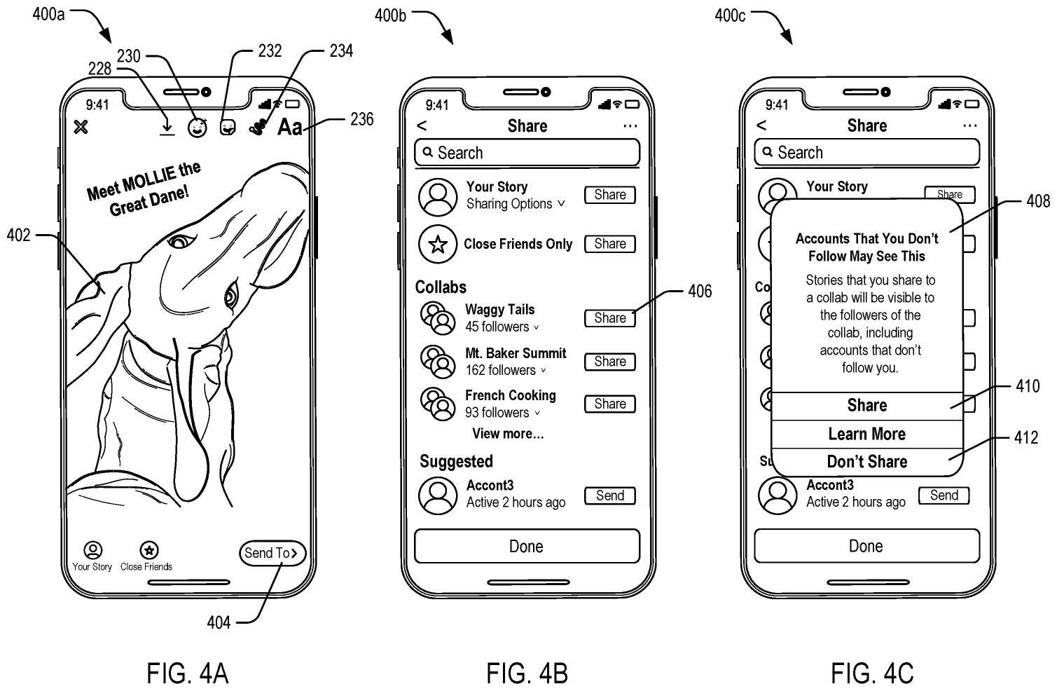

FIGS. 4A-4C illustrate example interfaces usable for the first account 102(1) and/or the second account 102(2) to add content to the collaborative story. For example, as illustrated in FIG. 4A, the second account 102(2) has created content 402 to associate with the collaborative story. Though illustrated as an image and text, this is not intended to be so limiting, and the content may additionally or alternatively include videos, audio, and/or posts by other accounts 102, to name a few non-limiting examples. Similar to example interface 200f, interface 400a may also include selectable controls 228, 230, 232, 234, and 236 which may allow the second account 102(2) to add, remove, and/or edit content to be posted to the collaborative story.

In some examples, the first account 102(1) and/or the second account 102(2) may access the interface 400a by selecting a selectable control that is associated with the collaborative story, such as selecting control 306 of FIG. 3B presented in a direct message between the first account 102(1) and the second account 102(2). The first account 102(1) and/or the second account 102(2) may additionally or alternatively access the interface 400a via a home page of a respective account, a profile of a respective account, and/or an existing story associated with the first account 102(1) and/or 102(2), to name a few non-limiting examples. The interface 400a may further include, for example, a selectable control 404 which, in response to selection, may cause the social networking system 106 to cause presentation of example interface 400b, as described in FIG. 4B.

FIG. 4B illustrates example interface 400b usable to select a location for publication of the content. For example, in response to selection of control 404, the social networking system 106 may cause presentation of one or more options for the second account 102(2) to send the content depicted in interface 400a. Locations may include, for example, a story of the second account 102(2) and/or a close friends list of the second account 102(2). In some examples, the social networking system 106 may cause presentation of one or more collaborative stories in which the second account 102(2) may be associated with. Additionally, the social networking system 106 may cause presentation of selectable controls associated with the one or more locations to share the content. For example, the second account 102(2) may select control 406 which may allow the second account 102(2) to share the content 402 to the “Waggy Tails” collaborative story.

In some examples, as illustrated by example interface 400c in FIG. 4C, the social networking system 106 may cause presentation of a notification to the second account 102(2) reminding the second account 102(2) that content shared to the collaborative story may be visible to accounts 102 that the second account 102(2) may not be associated with. For example, In response to selection of the control 406, the social networking system 106 may determine that the collaborative story that the user associated with the second account 102(2) wishes to share the content with may have one or more accounts 102(3)-102(n) that follow the collaborative story, but that do not follow the second account 102(2). In response to determining the one or more accounts 102(3)-102(n), the social networking system 106 may cause presentation of a notification 408. The notification 408 may include a selectable control 410 which, in response to selection, may cause the social networking system 106 to share the content to the collaborative story. Additionally, the notification 408 may include selectable control 412 which, in response to selection, may cause the social networking system 106 to refrain from sharing the content to the collaborative story.

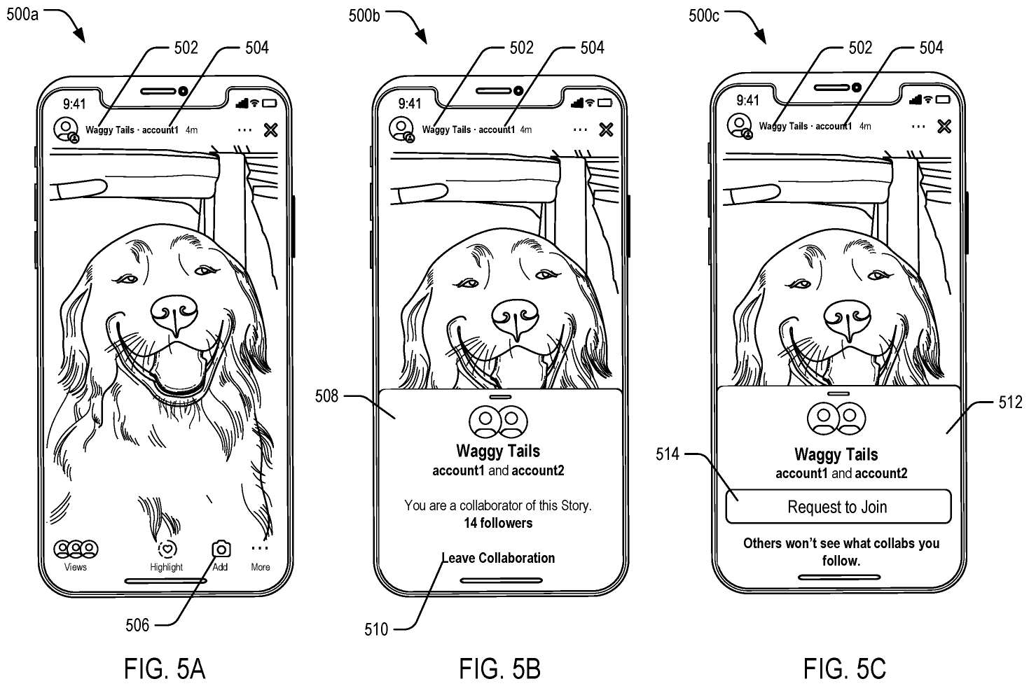

FIGS. 5A-5C illustrate example interfaces usable to view a collaborative story. FIG. 5A illustrates an example interface 500a illustrating the collaborative story as viewed by the first account 102(1). For example, the interface 500a may include the name of the collaboration 502 and/or an indication of the account 102 that posted the content to the collaborative story 504. Further, the interface 500a may include a selectable control 506 which, in response to selection, may allow the first account 102(1) to add additional content to the collaborative story.

FIG. 5B illustrates an example interface 500b, similar to that illustrated in FIG. 5A, as viewed by the second account 102(2). Similar to example interface 500a, example interface 500b may include the name of the collaborative story 504 and an indication of the account 102 that posted the content to the collaborative story. In some examples, the name of the collaborative story 504 may be a selectable icon in which, In response to selection, the social networking system 106 may cause presentation of notification 508, which may include information relating to the collaborative story, such as, for example, a name of the collaborative story, one or more accounts 102(n) associated with the collaborative story, a number of followers of the collaborative story, and/or an indication whether the account 102 viewing the collaborative story is a collaborator of the story, to name a few examples. Additionally, the notification 508 may include selectable control 510, which, in response to selection by the second account 102(2), may cause the social networking system 106 to remove the identifier associated with the second account 102(2) from the collaborative story.

FIG. 5C illustrates an example interface 500c, similar to that illustrated in FIGS. 5A and 5B, as viewed by a third account 102(3) not currently designated as a collaborator associated with the collaborative story For example, In response to selection of the name of the collaborative story 504 by the third account 102(3), the social networking system 106 may cause presentation, via the third account 102(3), of a notification 512. The notification 512 may be similar to notification 508 illustrated in FIG. 5B, and may include information relating to the collaborative story, such as, for example, a name of the collaborative story, one or more accounts 102(n) associated with the collaborative story, and/or a number of followers of the collaborative story. Additionally, the notification 512 may include a selectable control 514, which, in response to selection by the third account 102(3), may send a request to the social networking system 106 for the third account 102(3) to be designated as a collaborator of the collaborative story. IN response to receiving an indication of selection of the selectable control, the social networking system may cause presentation, in association with the first account 102(1) and/or the second account, of a notification of the request for the third account 102(3) to be associated with the collaborative story as a collaborator. In response to receiving an indication of approval of the request from the first account 102(1) and/or the second account 102(2), the social networking system 106 may designate the third account 102(3) as a collaborator to the collaborative story.

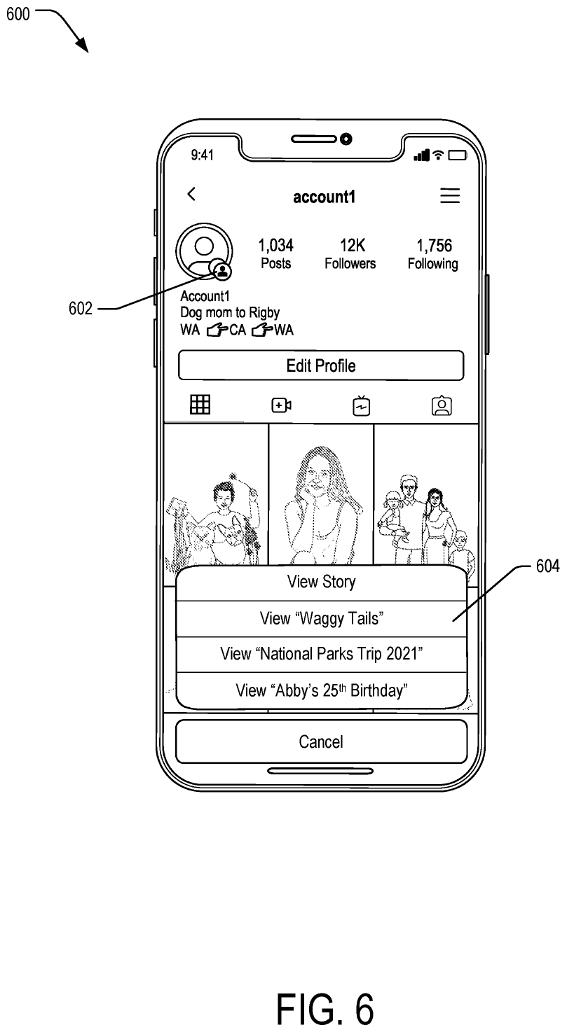

FIG. 6 illustrates example interface 600 usable to view collaborative stories from a profile of the first account 102(1). In some examples, the profile of the first account 102(1) may include a selectable icon 602, indicating that the first account 102(1) is associated with one or more stories. In response to selection of the icon 602, the social networking system 106 may cause presentation of options to view the one or more stories of the first account 102(1). For example, the social networking system may cause presentation of selectable control 604, which, in response to selection, may cause presentation of the story “Waggy Tails” to the account 102 viewing the profile of the first account 102(1). In some examples, the social networking system 106 may determine that the account viewing the profile of the first account 102(1) is a follower of the first account 102(1). Based on determining the viewing account is a follower of the first account 102(1), the social networking system 106 may cause presentation of the collaborative story to the viewing account. Alternatively, in some examples, the social networking system 106 may determine that the account viewing the profile of the first account 102(1) is a not a follower of the first account 102(1). Based on determining the viewing account is not a follower of the first account 102(1), the social networking system 106 may refrain from presenting the collaborative story to the viewing account.

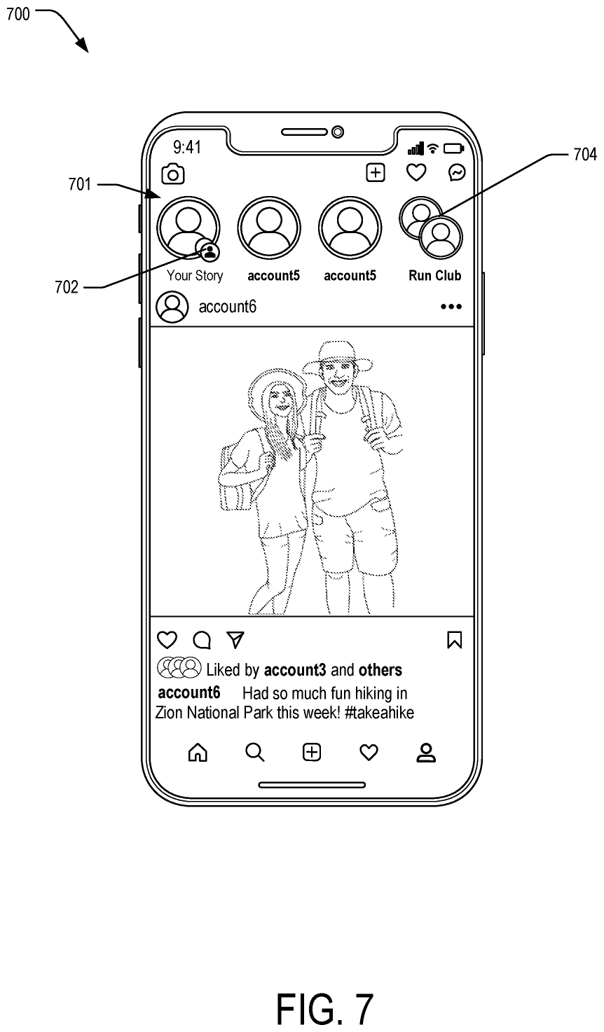

FIG. 7 illustrates an example interface 700 usable to view collaborative stories from a feed 701 of an account 102. In the illustrative example, a first icon 702 associated with the account 102 includes a selectable control enabling a user associated with the account to access a personal (e.g., individual story). The feed 701 may additionally include one or more personal stories associated with other accounts to which the account is connected (e.g., following, friends, etc.). For example, the feed 701 includes a first story associated with “accounts” and a second story associated with “account6.”

In some examples, the feed 701 may additionally or alternatively include one or more icons associated with collaborative stories, such as icon 704. In some examples, a presentation of two or more avatars or user account indicators may provide an indication that a story is a collaborative story. For example, the icon 704 includes two avatars associated with the collaborators of the collaborative story “Run Club.”

In some examples, in response to receiving an indication of selection of the icon 704, the social networking system 106 may cause presentation, via the first account 102(1), of the collaborative story “Run Club.” In various examples, the social networking system 106 may rank the individual and/or collaborative stories to which the first account 102(1) is associated. That is, the social networking system 106 may be configured to identify most likely content the user would want to view, and presents stories associated therewith in the feed 701.

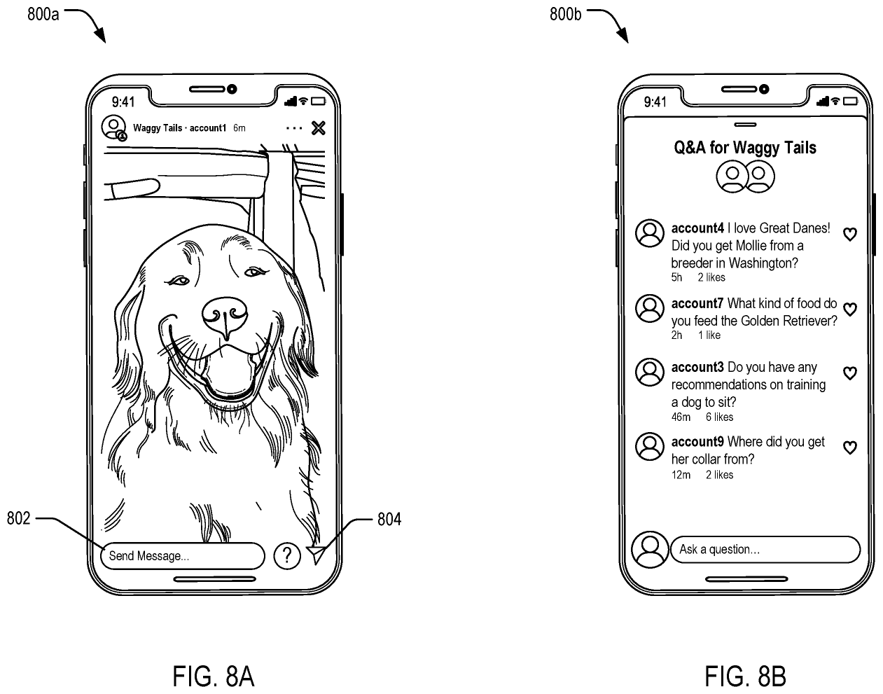

FIGS. 8A and 8B illustrate example interfaces usable for accounts 102(3)-102(n) to comment on a collaborative story. FIG. 8A illustrates example interface 800a, which may be presented to a third account 102(3) who may be a follower of the collaborative story. In some examples, the example interface 800a may include a selectable text box 802, in which third account 102(3) may leave a comment. In response to selection of an icon 804 by the third account 102(3), the social networking system 106 may send the comment by the third account 102(3) to the first account 102(1) and/or the third account 102(3).

In some examples, the social networking system 106 may receive, from the first account 102(1) and/or the second account 102(2), a response to the comment. The social networking system 106 may then cause presentation the comment and/or the response to the comment in a communication interface, such as a story viewer, as illustrated by example interface 800b in FIG. 8B. The communication interface 800b may include one or more comments from one or more accounts 102 following the collaborative story. In some examples, the accounts 102 following the collaborative story may like and/or comment on previous comments, allowing for greater interaction between the first account 102(1) and the second account 102(2) posting content to the collaborative story and the accounts 102(3)-102(n) following the collaborative story.

### Example Methods

Various methods are described with reference to the example system of FIG. 1 for convenience and ease of understanding. However, the methods described are not limited to being performed using the system of FIG. 1 and may be implemented using systems and devices other than those described herein.

The methods described herein represent sequences of operations that can be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes. In some examples, one or more operations of the method may be omitted entirely. Moreover, the methods described herein can be combined in whole or in part with each other or with other methods.

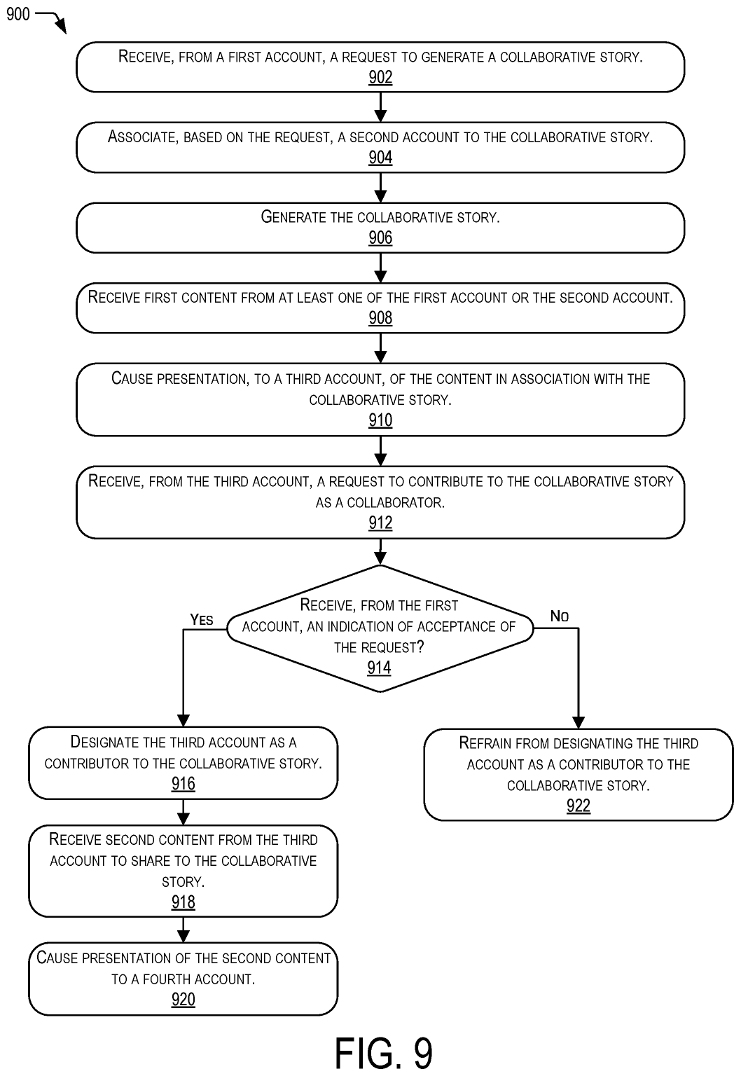

FIG. 9 depicts an example process 900 for providing users associated with accounts the ability to create and associate one or more other accounts to a collaborative story. For example, at operation 902, the process may include receiving, from a first account, a request to generate a collaborative story. The collaborative story may include a collection of content items that are provided by other user accounts designated as contributors to the collaborative story. For example, the collaborative story may include text and/or media content items, such as images, video, and/or audio published via a social networking system. In some examples, the request may include an identifier associated with a second account that is to be associated with the collaborative story. The identified may include, for example, a code, a label, or other discrete identifier that is associated with the second account.

At operation 904, in response to receiving the request including the identifier associated with the second account, the process may include associating a second account to the collaborative story. For example, the second account may contribute to the collaborative story, allowing both the first account and the second account to share to the collaborative story.

At operation 906, the process may include generating the collaborative story. In some examples, the first account and the second account may be designated as collaborators to the collaborative story. In other words, both the first account and the second account may post content to the collaborative story from their separate accounts.

At operation 908, the process may include receiving first content from at least one of the first account or the second account. As described above, content may take a variety of forms, such as text and/or media content items, such as images, video, and/or audio. In some examples, the content may be an item of ephemeral content. For example, as described above with respect to the collaborative story, content shared to the collaborative story may be removed from being viewed by followers of the collaborative story after a threshold period of time (e.g., one hour, one day, one week, etc.).

At operation 910, the process may include causing presentation, via a third account, of the content in association with the collaborative story. In some examples, the collaborative story may be presented via a display of a computing device associated with the third account. In some examples, the process may include causing presentation of an indication of at least one of the first account and/or the second account associated with a publisher of a particular content item associated with the collaborative story. In this way, the third account may identify the account that posted the content to the collaborative story.

At operation 912, the process may include receiving, from a user associated with the third account, a request to contribute to the collaborative story as a contributor. In response to receiving the request, the process may include sending, to the first account and/or the second account, an option to approve or deny the request. For example, the option to accept or deny the request may be sent to the “owner,” “initiator,” or “administrative” account (e.g., the first account) that is associated with the collaborative story.

At operation 914, the process may include determining whether the first account accepted the request. For example, the first account may decide whether the first account believes the content the third account may post to the collaborative story is content relevant to the collaborative story.

At operation 916, in response to determining that the first account accepted the request (“Yes” at operation 914), the process may include designating the third account as a collaborator to the collaborative story. Similar to the first account and the second account, the third account may have the ability to post content to the collaborative story.

At operation 918, the process may include receiving second content from the third account to share to the collaborative story. Similar to the first content, second content may include text and/or media content items, such as images, video, and/or audio. In some examples, the content may be an item of ephemeral content. For example, as described above with respect to the collaborative story, content shared to the collaborative story may be removed from being viewed by followers of the collaborative story after a threshold period of time (e.g., one hour, one day, one week, etc.).

At operation 920, the process may include causing presentation of the second content to a fourth account. In some examples, the second content may be presented via a display of a computing device associated with the fourth account. The presentation may further include, in some examples, an indication of the third account. In this way, the fourth account may identify the account that posted the second content to the collaborative story.

At operation 922, in response to determining that the first account did not accept the request (“No” at operation 914), the process may include refraining from designating the third account as a collaborator to the collaborative story. In some examples, the third account may be granted access (e.g., include permissions) to view the first content received from at least one of the first account or the second account, but may not be associated with the collaborative story as a collaborator.

### Example System and Device

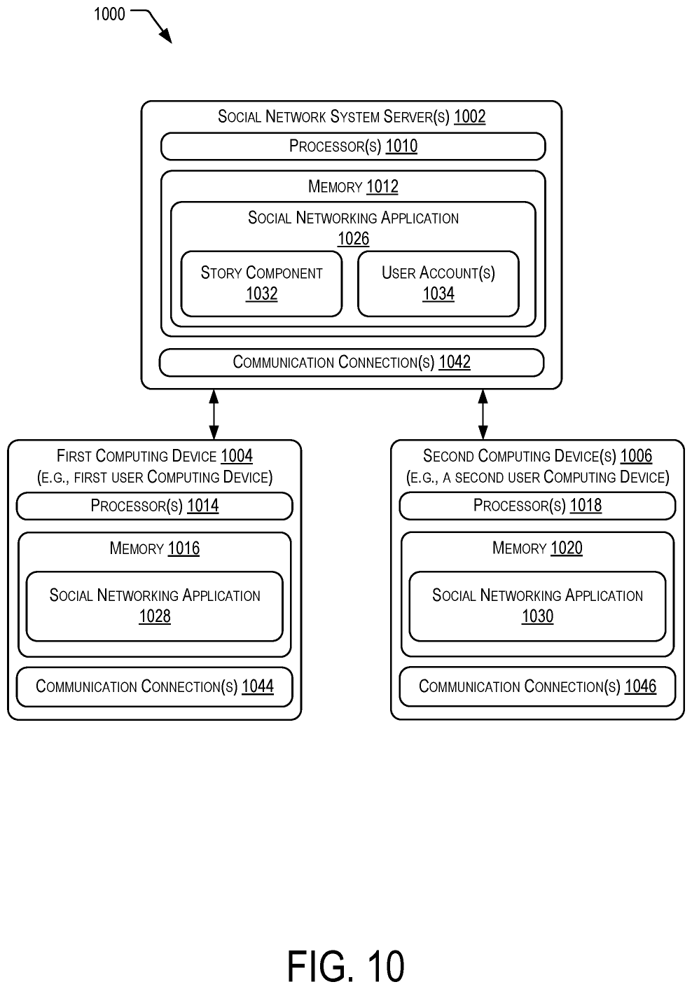

FIG. 10 illustrates a block diagram illustrating an example system 1000 of computing devices usable to implement example techniques described herein. For example, FIG. 10 illustrates example computing devices including one or more social network system servers 1002, a first computing device 1004, and a second computing device 1006, that interact over a network, such as network 108 of FIG. 10. By way of example and not limitation, the social network system server(s) 1002 may be representative of servers used to implement the system 100, the first computing device 1004 may be representative of the first user computing device 104(1) associated with the first user 102(1), and the second computing device 1006 may be representative of the second user computing device 104(2) associated with the second user 102(2).

The social network system server(s) 1002 may comprise one or more individual servers or other computing devices that may be physically located in a single central collection or may be distributed at multiple different locations. The social network system server(s) 1002 may be hosted privately by an entity administering all or part of the communications network (e.g., a utility company, a governmental body, distributor, a retailer, manufacturer, etc.), or may be hosted in a cloud environment, or a combination of privately hosted and cloud hosted services.

Each of the computing devices described herein may include one or more processors and/or memory. Specifically, in the illustrated example, social network system server(s) 1002 include one or more processors 1010 and memory 1012, the first computing device 1004 includes one or more processors 1014 and memory 1016, the second computing device 1006 includes one or more processors 1018 and memory 1020. By way of example and not limitation, the processor(s) may comprise one or more Central Processing Units (CPUs), Graphics Processing Units (GPUs), or any other device or portion of a device that processes electronic data to transform that electronic data into other electronic data that may be stored in registers and/or memory. In some examples, integrated circuits (e.g., ASICs, etc.), gate arrays (e.g., FPGAs, etc.), and other hardware devices may also be considered processors in so far as they are configured to implement encoded instructions.

The memory may comprise one or more non-transitory computer-readable media and may store an operating system and one or more software applications, instructions, programs, and/or data to implement the methods described herein and the functions attributed to the various systems. In various implementations, the memory may be implemented using any suitable memory technology, such as static random-access memory (SRAM), synchronous dynamic RAM (SDRAM), nonvolatile/Flash-type memory, or any other type of memory capable of storing information. The architectures, systems, and individual elements described herein may include many other logical, programmatic, and physical components, of which those shown in the accompanying figures are merely examples that are related to the discussion herein.

As shown in FIG. 10, the social network system server(s) 1002 include a social networking application 1026, the first computing device 1004 includes social network client application 1028, and the second computing device 1006 includes social network client application 1030 that enables interaction of content among the computing devices via the social network system server(s) 1002. For example, content (e.g., text, images, audio, video, GIFs, emojis, and/or the like associated with posts, comments to posts, direct messages, etc.) can be shared among users associated with social networking accounts (e.g., user accounts 1034) of an online social network provided by the social networking system and may include sharing content in accordance with a user account of a user that is restricted. In various examples, data associated with user accounts of users of the social networking system may be stored in association with the social networking application 1026, such as in the user accounts 1034. In some examples, the user accounts 1034 may be personal accounts associated with an individual user or business accounts associated with a business of a user (e.g., merchant accounts). In some examples, the messaging client application enables interfaces to access content, to view content, and to generate content as those described with reference to FIGS. 2A-9B, for example. In particular examples, social networking system server(s) 1002 sends instructions to present, transmit, and receive content as discussed with reference to FIGS. 2A-9B.

FIG. 10 further illustrates social networking system server(s) 1002 as including story component 1032, such as story component 110, to enable functionality with regard to generating collaborative stories, as described herein. For example, the story component may include functionality associated with generating a collaborative story associated with a first user of a first account and a second user of a second account.

In various examples, the story component 1032 may be configured to designate the first account and/or the second account as contributors to the collaborative story. As described above, as collaborators of the collaborative story, the first account and/or the second account may send content to be posted to the collaborative story. In some examples, the content may be presented to other user accounts via a display of a computing device associated with the other accounts.

As shown in FIG. 10, social networking system server(s) 1002 include communications connection(s) 1042, the first computing device 1004 includes communications connection(s) 1044, and the second computing device 1006 includes communications connection(s) 1046 that enables communication between two or more of the social networking system server(s) 1002, the first computing device 1004, and the second computing device(s) 1006, and/or additional computing device(s).

The communication connection(s) 1042, 1044, and/or 1046, can include physical and/or logical interfaces for connecting social networking system server(s) 1002, the first computing device 1004, and/or the second computing device 1006 to another computing device or a network, such as network(s) 108. For example, the communications connection(s) 1042, 1044, and/or 1046 can enable Wi-Fi-based communication such as via frequencies defined by the IEEE 802.10 standards, short range wireless frequencies such as Bluetooth®, cellular communication (e.g., 2G, 2G, 4G, 4G LTE, 5G, etc.) or any suitable wired or wireless communications protocol that enables the respective computing device to interface with the other computing device(s).

While FIG. 10 is provided as an example system 1000 that can be used to implement techniques described herein, the techniques described and claimed are not limited to being performed by the system 1000, nor is the system 1000 limited to performing the techniques described herein.

### CONCLUSION

Although the discussion above sets forth example implementations of the described techniques, other architectures may be used to implement the described functionality and are intended to be within the scope of this disclosure. Furthermore, although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method comprising:
receiving, from a first account of a social networking system, a request to generate an ephemeral collection of content items, wherein the request includes an identifier associated with a second account of the social networking system that is to be associated with the ephemeral collection of content items and wherein the ephemeral collection of content items is a collaboration between two or more accounts of the social networking system;
associating, based on the request, the second account with the ephemeral collection of content items;
in response to associating the second account, generating the ephemeral collection of content items, wherein the first account and the second account are designated as collaborators;
receiving content from at least one of the first account or the second account to share to the ephemeral collection of content items; and
causing presentation, via a display of a computing device associated with a third account, of the content in association with the ephemeral collection of content items, the content having associated therewith an indication of the at least one of the first account or the second account associated with the content.

2. The method of claim 1, further comprising:
receiving, from the second account, a request to dissociate from the ephemeral collection of content items; and
in response to receiving the request to dissociate, removing the identifier associated with the second account from the ephemeral collection of content items.

3. The method of claim 1, further comprising:
receiving, from the third account, a request to access the ephemeral collection of content items,
wherein causing the presentation of the ephemeral collection of content items via the display of the computing device associated with the third account is based on the request to access the ephemeral collection of content items.

4. The method of claim 1, further comprising:
receiving, from the third account, a request to join the ephemeral collection of content items as a collaborator;
causing presentation of at least a portion of the request, from the third account, to join the ephemeral collection of content items;
receiving, from the first account, an indication of acceptance of the request to join the ephemeral collection of content items; and
associating, based on receiving the indication, the third account with the ephemeral collection of content items, wherein the third account is designated as the collaborator.

5. The method of claim 4, wherein the content is first content, and the indication is a first indication, further comprising:
receiving second content from the third account to share to the ephemeral collection of content items; and
causing presentation, via display of another computing device associated with a fourth account, the second content and a second indication that the third account is associated with the second content,
wherein the fourth account is connected to at least one of the first account, the second account, or the third account via the social networking system.

6. The method of claim 1, further comprising:
determining that the first account is a public account;
determining that the second account is a private account,
wherein the third account is a follower of the public account; and
causing presentation, in association with the second account and based on determining that the first account is the public account, of a notification that sharing the content to the ephemeral collection of content items includes sharing content publicly.

7. The method of claim 1, wherein the content includes an item of ephemeral content.

8. The method of claim 1, further comprising:
receiving, from the third account, a comment in response to the content and associated with the ephemeral collection of content items;
receiving, from at least one of the first account or the second account, a response to the comment; and
causing presentation of at least one of the comment or the response in a communication interface associated with the ephemeral collection of content items.

9. The method of claim 1, further comprising:
providing, to the second account and based on an association with the ephemeral collection of content items, a selectable icon enabling the second account to invite other accounts to associate with the ephemeral collection of content items;
receiving, from the second account, a request to share the selectable icon to a story of the second account; and
in response to receiving the request, causing presentation of the selectable icon in association with the story of the second account.

10. The method of claim 1, further comprising:
determining that the first account and the second account are private accounts; and
determining that the third account is associated with the first account and the second account,
wherein causing presentation of the ephemeral collection of content items is based on determining that the third account is associated with the first account and the second account.

11. A system comprising:
one or more processors; and
computer-readable media storing instructions that, when executed by the one or more processors, cause the system to perform operations comprising:
receiving, from a first account of a social networking system, a request to generate an ephemeral collection of content items, wherein the request includes an identifier associated with a second account of the social networking system that is to be associated with the ephemeral collection of content items and wherein the ephemeral collection of content items is a collaboration between two or more accounts of the social networking system;
associating, based on the request, the second account with the ephemeral collection of content items;
in response to associating the second account, generating the ephemeral collection of content items, wherein the first account and the second account are designated as collaborators;
receiving content from at least one of the first account or the second account to share to the ephemeral collection of content items; and
causing presentation, via a display of a computing device associated with a third account, of the content in association with the ephemeral collection of content items, the content having associated therewith an indication of the at least one of the first account or the second account associated with the content.

12. The system of claim 11, the operations further comprising:
receiving, from the second account, a request to dissociate from the ephemeral collection of content items; and
in response to receiving the request to dissociate, removing the identifier associated with the second account from the ephemeral collection of content items.

13. The system of claim 11, the operations further comprising:
receiving, from the third account, a request to join the ephemeral collection of content items as a collaborator;
causing presentation of at least a portion of the request, from the third account, to join the ephemeral collection of content items;
receiving, from the first account, an indication of acceptance of the request to join the ephemeral collection of content items; and
associating, based on receiving the indication, the third account with the ephemeral collection of content items, wherein the third account is designated as the collaborator.

14. The system of claim 11, wherein the content is first content, and the indication is a first indication, the operations further comprising:
receiving second content from the third account to share to the ephemeral collection of content items; and
causing presentation, via display of another computing device associated with a fourth account, the second content and a second indication that the third account is associated with the second content,
wherein the fourth account is connected to at least one of the first account, the second account, or the third account via the social networking system.

15. The system of claim 11, the operations further comprising:
providing, to the second account and based on an association with the ephemeral collection of content items, a selectable icon enabling the second account to invite other accounts to associate with the ephemeral collection of content items;
receiving, from the second account, a request to share the selectable icon to a story of the second account; and
in response to receiving the request, causing presentation of the selectable icon in association with the story of the second account.

16. The system of claim 11, the operations further comprising:
determining that the first account is a public account;
determining that the second account is a private account,
wherein the third account is a follower of the public account; and
causing presentation, in association with the second account and based on determining that the first account is the public account, of a notification that sharing the content to the ephemeral collection of content items includes sharing content publicly.

17. One or more non-transitory computer-readable media storing instructions that, when executed by one or more processors of a server computing device, cause the server computing device to preform operations comprising:
receiving, from a first account of a social networking system, a request to generate an ephemeral collection of content items, wherein the request includes an identifier associated with a second account of the social networking system that is to be associated with the ephemeral collection of content items and wherein the ephemeral collection of content items is a collaboration between two or more accounts of the social networking system;
associating, based on the request, the second account with the ephemeral collection of content items;
in response to associating the second account, generating the ephemeral collection of content items, wherein the first account and the second account are designated as collaborators;
receiving content from at least one of the first account or the second account to share to the ephemeral collection of content items; and
causing presentation, via a display of a computing device associated with a third account, of the content in association with the ephemeral collection of content items, the content having associated therewith an indication of the at least one of the first account or the second account associated with the content.

18. The one or more non-transitory computer-readable media of claim 17, wherein the content includes an item of ephemeral content.

19. The one or more non-transitory computer-readable media of claim 17, the operations further comprising:
receiving, from the second account, a request to dissociate from the ephemeral collection of content items; and
in response to receiving the request to dissociate, removing the identifier associated with the second account from the ephemeral collection of content items.

20. The one or more non-transitory computer-readable media of claim 17, the operations further comprising:
determining that the first account and the second account are private accounts; and
determining that the third account is associated with the first account and the second account,
wherein causing presentation of the ephemeral collection of content items is based on determining that the third account is associated with the first account and the second account.
